(19) United States
(12) Patent Application Publication
(10) Pub. No.: US 2011/0262184 A1
(43) Pub. Date: Oct. 27, 2011

(54) Driver circuit, print head, and image forming apparatus

(75) Inventor: Akira Nagumo, Gunma (JP)

(73) Assignee: OKI DATA CORPORATION, Tokyo (JP)

(21) Appl. No.: 13/064,876

(22) Filed: Apr. 22, 2011

(30) Foreign Application Priority Data
Apr. 23, 2010 (JP) 2010-100208

(51) Int. Cl. G03G 15/04

(52) U.S. Cl. 399/177; 347/247

(57) ABSTRACT

A driver apparatus drives a plurality of light emitting thyristors. Each thyristor includes a cathode connected to the ground, an anode, and a gate. A gate driver circuit outputs a drive signal that electrically drives the gate. A level shifter circuit includes an input terminal connected to the driver circuit and an output terminal connected to the gate of the thyristor. The level shifter circuit operates such that the drive signal is shifted down in signal level and is outputted to the output terminal and a signal at the gate inputted to the output terminal is shifted down in signal level and is outputted to the input terminal. In response to the drive signal outputted from the driver circuit, a current supplying circuit supplies drive current to the anode of the thyristor such that the drive current flows from the anode to the cathode.

### BACKGROUND OF THE INVENTION

### Field of the Invention

The present invention relates to a driver circuit for cyclically selectively driving a row of a plurality of 3-terminal light emitting elements in a time division manner, e.g., light emitting thyristors as a light source, a print head incorporating the direr circuit, and an image forming apparatus, e.g., electrophotographic printer, incorporating the print head.

Some existing image forming apparatus such as an electrophotographic printer employ an exposing unit that employs arrays of light emitting thyristors. One such apparatus is disclosed in Japanese Patent Application Publication No. H03-194978. The light emitting thyristors include commonly connected gates and commonly connected anodes. Driver circuits drive the individual thyristors to run or not to run current from anode to cathode through the individual thyristors, thereby causing the light emitting thyristors to emit or not to emit light in a time division manner.

An existing print head employs a total of several thousand light emitting thyristors and many light emitting thyristors are turned on simultaneously. When a plurality of light emitting thyristors are turned on simultaneously, unwanted current flows between the gates of light emitting thyristors causing variations in drive current from anode to cathode. This results in variations in light output. Variations in light output cause uneven print densities, failing to provide sufficient print quality.

### SUMMARY OF THE INVENTION

A driver apparatus drives a plurality of light emitting thyristors. Each thyristor includes a cathode connected to the ground, an anode, and a gate. A driver circuit outputs a drive signal that electrically drives the gate. A level shifter circuit includes an input terminal connected to the driver circuit and an output terminal connected to the gate of the thyristor. The level shifter circuit operates such that the drive signal is shifted down in signal level and is outputted to the input terminal and a signal inputted to the output terminal is shifted down in signal level and is outputted to the input terminal. In response to the drive signal outputted from the driver circuit, a current supplying circuit supplies drive current to the anode of the thyristor such that the drive current flows from the anode to the cathode.

Further scope of applicability of the present invention will become apparent from the detailed description given hereinafter. However, it should be understood that the detailed description and specific examples, while indicating preferred embodiments of the invention, are given by way of illustration only, since various changes and modifications within the scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limiting the present invention, and wherein:

FIG. 1 illustrates the outline of an image forming apparatus according to a first embodiment;

FIG. 2 is a cross-sectional view of an optical print head;

FIG. 3 is a perspective view of a print circuit board;

FIG. 4 is a block diagram illustrating the configuration of a printer controller for use with the image forming apparatus;

FIG. 5 illustrates the circuit configuration of the optical print head;

FIG. 6A illustrates the symbol of a light emitting thyristor;

FIG. 6B is a cross-sectional view of the light emitting thyristor;

FIG. 6C is a cross-sectional view of another structure of a light emitting thyristor;

FIG. 6D is an equivalent circuit of the thyristor;

FIG. 7 is a block diagram illustrating the details of one of driver ICs;

FIG. 8 is a schematic diagram illustrating, by way of example, the configuration of a sub memory circuit;

FIG. 9 illustrates the configuration of a multiplexer shown in FIG. 7;

FIG. 10 is the schematic diagram of a driver;

FIG. 11 is a schematic diagram illustrating the configuration of a memory controller;

FIG. 12 a schematic diagram illustrating the configuration of a signal selector;

FIG. 13 illustrates the configuration of a control voltage generator;

FIGS. 14A-14D illustrate the conceptual representation of individual buffers;

FIG. 15 is a timing chart illustrating the transferring of the correction data performed in the optical print head;

FIG. 16 is a timing chart illustrating the printing operation of the optical print head;

FIG. 17 illustrates the details of the waveforms at portions A and B shown in FIG. 15;

FIG. 18 illustrates the details of the waveforms at portions C and D shown in FIG. 15;

FIG. 19 illustrates the details of the waveforms at portions E and F shown in FIG. 15;

FIG. 20 illustrates the details of the waveforms at portions G and H shown in FIG. 15;

FIGS. 21-1A to 21-1C illustrate the operation of the light emitting thyristor according to a first embodiment when it is turned on;

FIGS. 21-2A and 21-2B illustrate a comparative example;

FIG. 21-3A shows two buffers connected to the input terminals of a gate driver, and two odd-numbered light emitting thyristors connected to the output terminal of the gate driver;

FIG. 21-3B is an electrical equivalent circuit of the light emitting thyristors shown in FIG. 21-3A;

FIGS. 22A-22D are the conceptual representation of buffers according to a second embodiment;

FIGS. 23-1A to 23-1C illustrate the turn-on operation of the light emitting thyristor;

FIGS. 23-2A and 23-2B illustrate the simultaneous turn-on operation of the light emitting thyristors;

FIGS. 24A-24C are the conceptual representation of another buffer;

FIGS. 25A-25C illustrate the conceptual representation of still another buffer; and

FIGS. 26A-26C are the conceptual representation of yet another buffer.

### DETAILED DESCRIPTION OF THE INVENTION

### {Outline of Image Forming Apparatus}

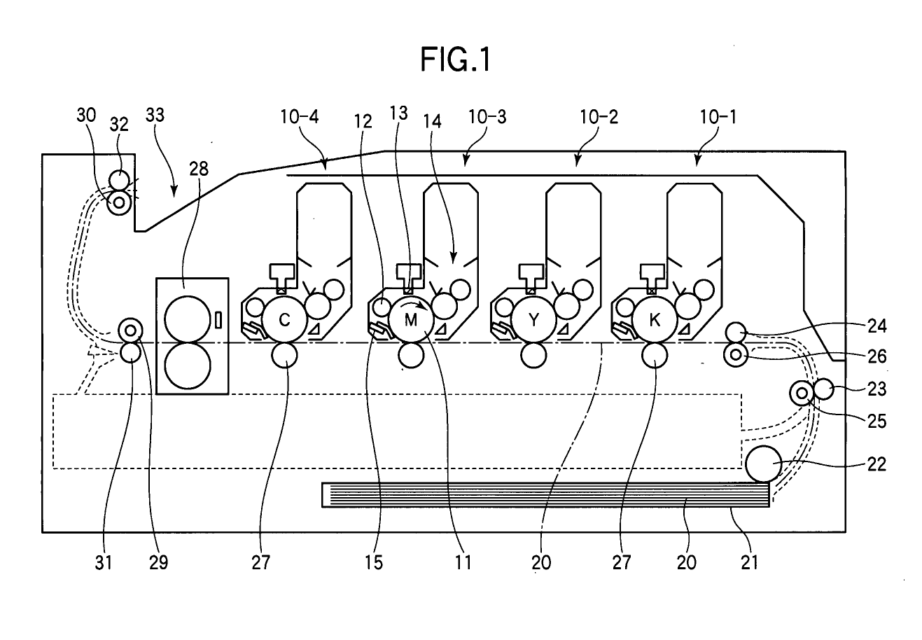

FIG. 1 illustrates the outline of an image forming apparatus according to a first embodiment.

The image forming apparatus 1 is an electrophotographic color printer that employs an exposing unit that incorporates light emitting elements, e.g., three-terminal thyristors. The image forming apparatus 1 includes four process units 10-1 to 10-4 that form black (K), yellow (Y), magenta (M), and cyan (C) images, respectively. The four process units are aligned from upstream to downstream of a transport path of a recording medium, e.g., paper 20. Each of the process units may be substantially identical; for simplicity only the operation of the process unit 10-3 for forming cyan images will be described, it being understood that the other process units may work in a similar fashion.

The process unit 10-3 includes a photoconductive drum 11 rotatable in a direction shown by arrow A. A charging unit 12, an exposing unit, e.g., an optical print head 13, a developing unit 14, and a cleaning device 15 are disposed in this order around the photoconductive drum 11. The charging unit 12 charges the surface of the photoconductive drum 11. The exposing unit 13 selectively illuminates the charged surface of the photoconductive drum 11 to form an electrostatic latent image. The developing unit 14 deposits magenta toner to the electrostatic latent image formed on the photoconductive drum 11 to form a toner image. The cleaning device 15 removes toner remaining on the photoconductive drum 11 after transferring the toner image onto the paper 20. A drive source (not shown) drives the photoconductive drum 11 and a variety of rollers in rotation via a gear train.

A paper cassette 21, which holds a stack of paper 20 therein, is disposed at a lower portion of the image forming apparatus 1. A hopping roller 22 is disposed over the paper cassette 21, and feeds the paper 20 on a sheet-by-sheet basis into the transport path. A transport roller 25 cooperates with pinch rollers 23 and 24 to hold the paper 20 in a sandwiched relation. A registry roller 26 corrects the skew of the paper 20, and transports the paper 20 to the process unit 10-1. The discharge roller 25 and registry roller 26 are disposed downstream of the hopping roller 22. A drive source (not shown) drives the hopping roller 22, discharge roller 25, and registry roller 26 in rotation via a gear train.

Transfer units 27 are formed of, for example, a semi-conductive rubber material, and parallel the photoconductive drums 11 of the process units 10-1 to 10-4. When the toner images formed on the photoconductive drums 11 are transferred onto the paper 20, the transfer units 27 receive voltages so as to create a potential difference across each transfer unit 27 and the surface of a corresponding photoconductive drum 11.

A fixing unit 28 is located downstream of the process unit 10-4, and includes a heat roller, which incorporates a heater therein, and a pressure roller. When the paper 20 passes through the gap between the pressure roller and the heat roller, the toner image on the paper 20 is fixed under heat and pressure. Discharge rollers 29 and 30, discharge pinch rollers 31 and 32, and a paper stacker 33 are disposed downstream of the fixing unit 28. The discharge rollers 29 and 30 cooperate with the pinch rollers 31 and 32 to hold the paper 20 in a sandwiched relation, and transport the paper 20 to the paper stacker 33. The heat roller, pressure roller, and discharge rollers 29 and 30 are driven in rotation by a drive power transmitted via, for example, a gear train from a drive source (not shown).

The image forming apparatus 1 operates as follows:

The hopping roller 22 feeds the paper 20 into the transport path from the paper cassette 21 on a sheet-by-sheet basis. The paper 20 is held by the transport roller 25, registry roller 26, and pinch rollers 23 and 24 in a sandwiched relation, and is transported into a transfer point defined between the photoconductive drum 11 of the process unit 10-1 and the transfer unit 27. As the photoconductive drum 11 rotates, the paper 20 is further transported through the transfer point so that the toner image on the photoconductive drum 11 is transferred onto the paper 20. Likewise, the paper 20 is transported through the remaining process units 10-2 to 10-4 so that the toner images of corresponding colors are transferred onto the paper 20 in registration.

When the paper 20 passes through the fixing unit 28, the toner images carried on the paper 20 are fixed. The paper 20 is further transported by the discharge rollers 29 and 30 and pinch rollers 31 and 32 to the paper stacker 33 defined on the outer wall of the image forming apparatus 1. This completes printing.

### {Construction of Optical Print Head}

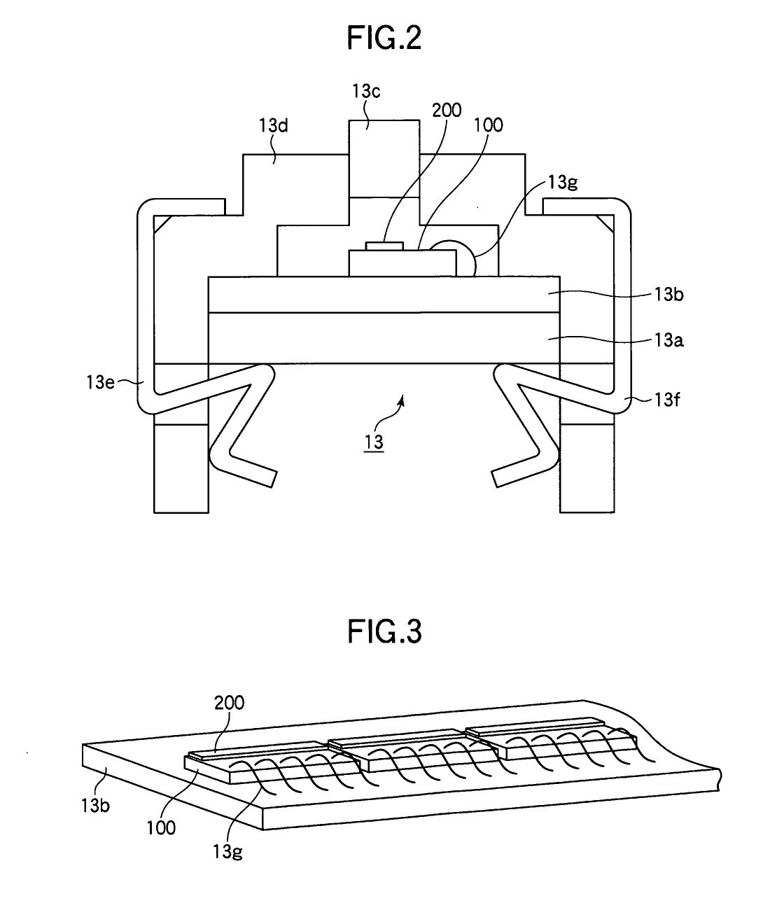

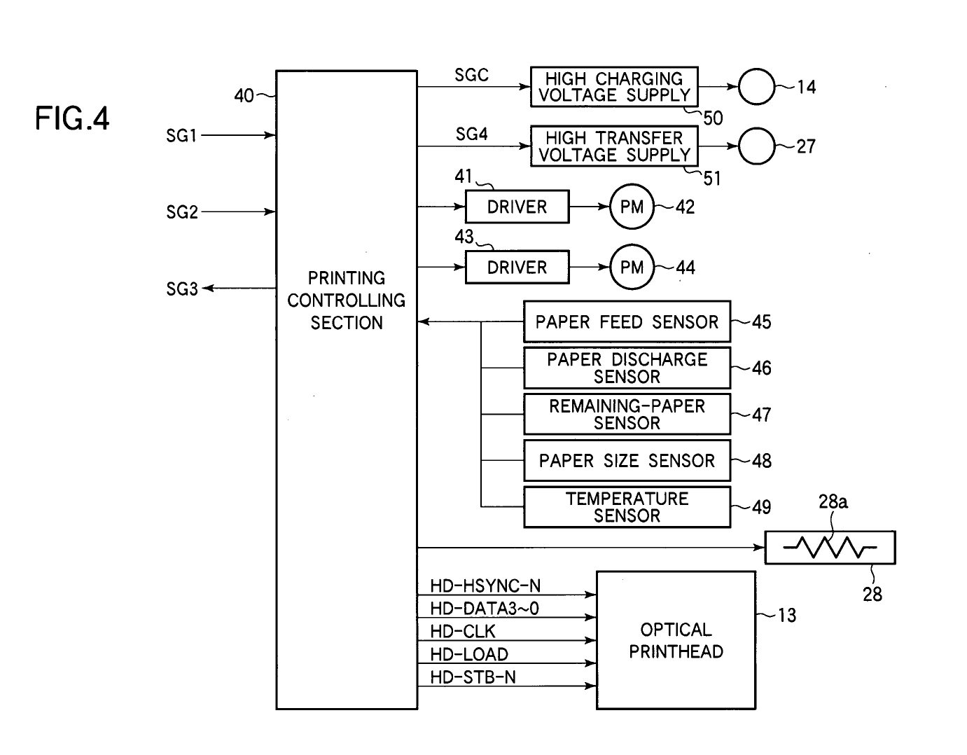

FIG. 2 is a cross-sectional view of the optical print head 13 shown in FIG. 1. FIG. 3 is a perspective view of a print circuit board shown in FIG. 2.

The optical print head 13 includes a base 13a and a printed wiring board 13b fixed on the base 13a. The printed wiring board 13b carries a plurality of driver circuits 100 (e.g., driver ICs at the bare chip level) mounted by means of, for example, thermosetting resin. A plurality of arrays 200 of light emitting elements (e.g., light emitting thyristors) are disposed on the driver ICs 100. The arrays 200 are electrically connected to the driver ICs 100 by means of thin film wirings of the driver ICs are electrically connected to the wiring pads of the printed wiring board 13b by bonding wires.

A rod lens array 13c, which incorporates a plurality of columns of optical elements, is located over the driver ICs. The rod lens array 13c is fixedly supported by a holder 13d. Clamp members 13e and 13f firmly hold the base 13a, printed wiring board 13b, and holder 13d together.

### {Printer Controller}

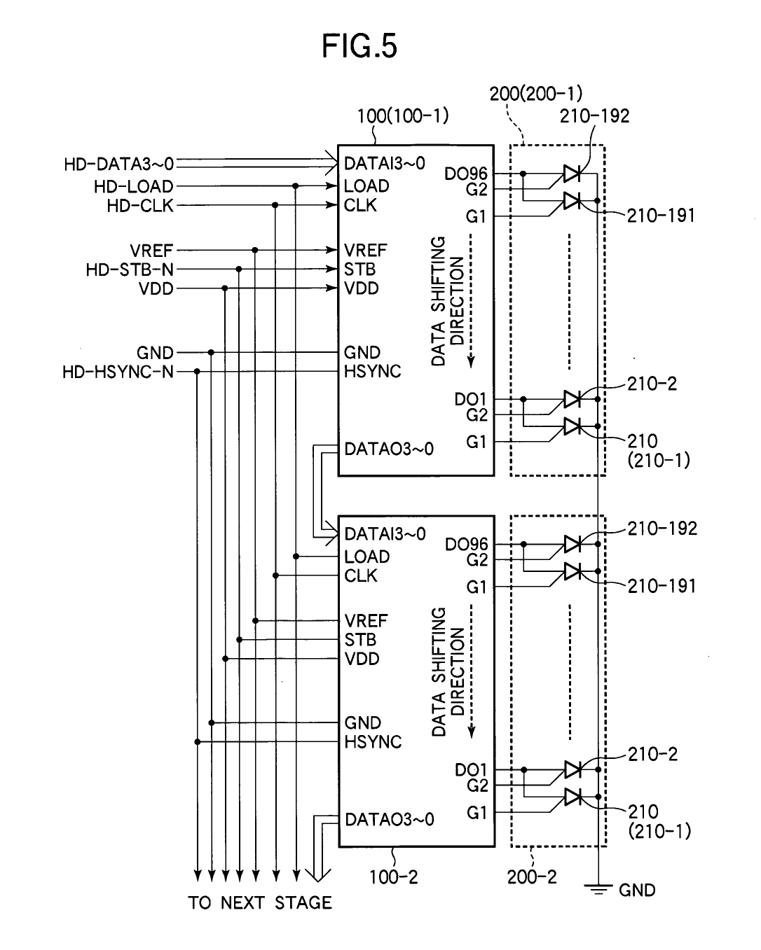

FIG. 4 is a block diagram illustrating the configuration of a printer controller for use with the image forming apparatus 1 shown in FIG. 1.

The printer controller includes a printing controller 40 located in a printing section of the image forming apparatus 1. The printing controller 40 mainly includes a microprocessor, a read only memory (ROM), a random access memory (RAM), an input/output port, and a timer. The printer controller receives a control signal SG1 and a video signal (bit map data arranged in a straight line) SG2 from an image processing section (not shown) to perform sequential control of the overall operation of the image forming apparatus 1, thereby performing printing. The printing controller 40 is connected to the four optical print heads 13 of the process units 10-1 to 10-4, a heater 28a of the fixing unit 28, drivers 41 and 43, an incoming paper sensor 45, an outgoing paper sensor 46, a remaining paper sensor 47, a paper size sensor 48, a fixing unit temperature sensor 49, a high voltage charging power supply 50, and a high voltage transferring power supply 51. The driver 41 is connected to a developing/transferring process motor (PM) 42. The driver 43 is connected to a paper transporting motor (PM) 44. The high voltage charging power supply 50 is connected to the developing unit 14. The high voltage transferring power supply 51 is connected to transfer units 27.

The printing controller 40 operates as follows:

Upon reception of the control signals SG1 to command printing from the image processing section, the printing controller 40 determines by means of the temperature sensor 49 whether the heat roller in the fixing unit 28 is in a usable temperature range. If the temperature is not within the usable temperature range, the printing controller 40 supplies electric power to the heater 28a to heat the heat roller to the usable temperature. The printing controller 40 then causes the driver 41 to rotate the developing/transfer process motor 42, and outputs a charging signal SGC to turn on the high voltage charging power supply 50, thereby charging the developing unit 14.

Then, the remaining paper sensor 47 detects whether the paper 20 is present in the paper cassette and the paper size sensor 48 detects the size of the paper 20. Thus, the paper 20 of the right size is fed to the transport path. The paper transporting motor 44 is coupled to a planetary gear assembly and is adapted to rotate in the forward and reverse directions. Switching the rotation direction of the paper transporting motor 44 allows switching of the rotation directions of the transport rollers 25, depending on the size of the paper 20.

When printing on one page of paper is started, the paper transporting motor 44 is rotated in the reverse direction, thereby transporting the paper 20 by a predetermined amount until the incoming paper sensor 45 detects the paper 20. The paper transporting motor 44 is then rotated in the forward direction to transport the paper 20 into a print engine of the image forming apparatus 1.

When the paper 20 reaches a position where printing can be performed, the printing controller 40 provides a timing signal SG3 including a main scanning sync signal and a sub scanning sync signal to an image processing section (not shown), and receives the video signal SG2. The video signal SG2 is edited on a page-by-page basis in the image processing section and is received by the print controller 40. The video signal SG2 is transferred as print data signals HD-DATA3 to HD-DATA0 and supplied to the respective optical print heads 13. Each of the optical print heads 13 incorporates a plurality of light emitting thyristors, each thyristor forming a dot or pixel of an image.

Upon reception of the video signal SG2 for one line, the printing controller 40 provides the latch signal HD-LOAD to the respective optical print heads 13. In response to the latch signal HD-LOAD, the respective optical print heads 13 hold the print data signals HD-DATA3 to HD-DATA0. The printing controller 40 is adapted to perform printing of the print data signals HD-DATA3 to HD-DATA0 held in the respective optical print heads 13 while the printing controller 40 is receiving the next video signals SG2 from the image processing section.

The printing controller 40 provides the clock signal HD-CLK, a main scanning sync signal HD-HSYNC-N, and a print drive signal HD-STB-N to the respective optical print heads 13. The clock signal HD-CLK is used to send the print data signals HD-DATA3 to HD-DATA0 to the optical print heads 13.

The video signal SG2 is transmitted and received on a line-by-line basis. The optical print head 13 illuminates the negatively charged surface of the photoconductive drum 11 to form an electrostatic latent image formed of dots having increased potential due to exposure to light. The toner is negatively charged in the developing unit 14 and is then attracted to the dots formed on the photoconductive drum 11 by the Coulomb force, thereby forming a toner image.

The toner image on the photoconductive drum 11 is then transported to the transfer point defined between the photoconductive drum 1 and the transfer unit 27. A transfer signal SG4 causes the high voltage transfer power supply 51 to turn on to apply a positive voltage, thereby transferring the toner image onto the paper 20 as the paper 20 passes through the transfer point. The paper 20 carries the toner image thereon and passes through the fixing point defined between the heat roller and pressure roller of the fixing unit 28, so that the toner image is fixed under heat and pressure. The paper 20 is then further transported past the outgoing paper sensor 46.

In response to the detection signals from the paper size sensor 48 and incoming paper sensor 45, the printing controller 40 causes the high voltage transfer power supply 51 to turn on to apply the high voltage to the transfer unit 27 while the paper 20 is passing the transfer point. When the paper 20 has passed the outgoing paper sensor 46 after completion of printing, the printing controller 40 causes the high voltage charging power supply 50 to stop applying the high voltage to the developing section 14, and the developing/transferring process motor 42 to stop rotating. The above-described operation is repeated until the entire print data has been printed.

### {Circuit of Optical Print Head}

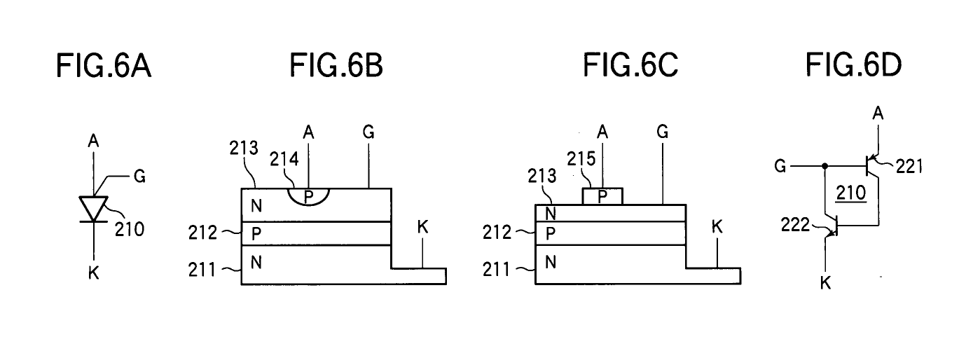

FIG. 5 illustrates the circuit configuration of the optical print head 13 shown in FIG. 4.

The optical print head 13 is capable of forming an electrostatic latent image on the photoconductive drum at a resolution of, for example, 600 dpi and includes 4992 light emitting thyristors for forming 4992 dots on A4 size paper.

The optical print head 13 includes the printed wiring board 13b (FIG. 3) on which a plurality of driver ICs 100 (e.g., 26 driver ICs) for driving 4992 light emitting thyristors are mounted to form a total of 4992 dots. FIG. 5 shows only two driver ICs, i.e., driver ICs 100-1 and 100-2 and two corresponding light emitting thyristor arrays 200-1 and 200-2 arranged on the driver ICs. The driver IC 100-1 drives the light emitting thyristor array 200-1 and the driver IC 100-2 drives the light emitting thyristor array 200-2. Each thyristor array includes a total of 192 light emitting thyristors 211-1 to 211-96 and 212-1 to 212-96 whose cathodes are connected to the ground terminal GND. Each light emitting thyristor has a cathode connected to a power supply (e.g., ground, GND). The 192 light emitting thyristors form 96 pairs of adjacent odd-numbered and even-numbered thyristors. The anodes of each pair (e.g., thyristors 211-1 and 212-2) are commonly connected together to a corresponding one of the drive current output terminals DO1 to DO96 of the driver IC 100 by means of the film wirings. The odd-numbered and even numbered light emitting thyristors are driven alternately in a time division manner. A total of 26 driver ICs 100 are of an identical configuration, and are cascaded.

Data input terminals DATAI3 to DATAI0 receive print data signals HD-DATA3 to HD-DATA0. A latch signal terminal LOAD receives a latch signal HD-LOAD. A CLK terminal receives a clock signal HD-CLK. A VREF terminal receives a reference voltage VREF. An STB terminal receives the print drive signal HD-STB-N, which serves as a strobe signal. A VDD terminal receives a power supply voltage VDD. The ground terminal GND is connected to the ground. A HSYNC terminal receives the main scanning sync signal HD-HSYNC-N. Output data terminals DATAO3 to DATAO0 output the data to the next stage driver IC.

The drive current output terminals DO1-DO96 supply drive currents to the anodes of the light emitting thyristors 210 in the light emitting thyristor arrays.

A gate drive signal terminal G1 outputs a gate drive signals that drives the gates of the odd-numbered light emitting thyristors 210 through a common wire 220a. Agate drive signal terminal G2 outputs a gate drive signal that drives the gates of the even-numbered light emitting thyristors 210.

### {Operation of Optical Print Head}

The operation of the optical print head 13 of the above-described configuration shown in FIG. 5 will be described. The print data signals HD-DATA3 to HD-DATA0 are outputted simultaneously on the clock signals HD-CLK, and drive adjacent four light emitting thyristors for either odd-numbered or even-numbered 4 pixels. For this operation, the print controller 40 shown in FIG. 4 outputs the print data signals HD-DATA3 to HD-DATA0 to the data input terminals DATAI3 to DATAI0 of the first driver IC 100-1, and the clock signals HD-CLK to the CLK terminals of all the driver ICs 100-1 to 100-26. The print data signals HD-DATA3 to HD-DATA0 are shifted through the driver ICs on the clock signal. The print data is bit data for a total of 4992 bits (i.e., 4992 dots): 2496 odd-numbered bits and 2496 even-numbered bits. The bit data for the odd-numbered dots is first shifted through shift registers implemented with flip-flops in the driver ICs, and then the bit data for the even-numbered dots is shifted through the same shift registers.

Next, the latch signal HD-LOAD is inputted to the latch signal terminals LOAD of all the driver ICs 100, so that the bit data in the shift register is latched into the latch circuit in the form of flip-flops (FFs). The High levels of the bit data latched in the latch circuit drive the light emitting thyristors 210-1 to 210-192, which are connected to the drive current output terminals DO1, DO2, . . . D96 terminals, to turn on upon the print drive signal HD-STB-N.

Each driver IC 100 receives the power supply voltage VDD, ground potential GND, the main scanning sync signal HD-HSYNC-N, and the reference voltage VREF. The main scanning sync signal HD-HSYNC-N indicates whether the odd-numbered light emitting thyristors should be driven or the even-numbered light emitting thyristors should be driven. The reference voltage VREF is used to set the drive current for driving the light emitting thyristors. The reference voltage VREF is generated by a regulator circuit (not shown) in the optical print head 13.

### {Light Emitting Thyristor}

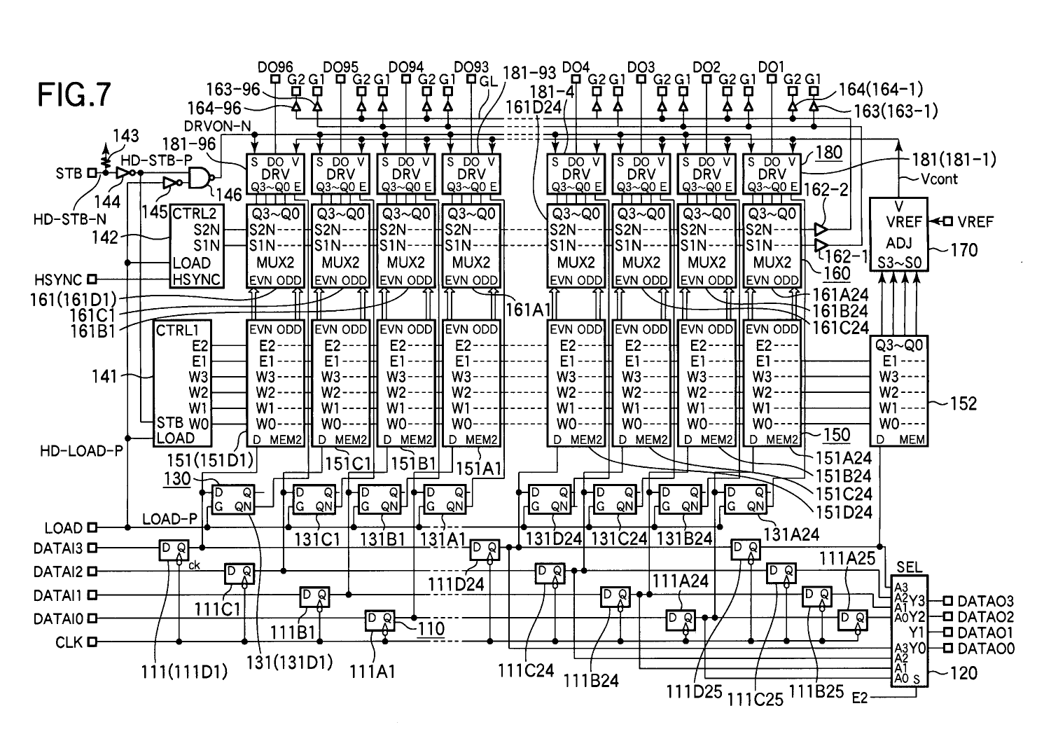

FIGS. 6A-6D illustrate the structures of the light emitting thyristor 210 shown in FIG. 5.

FIG. 6A illustrates the symbol of the thyristor.

FIG. 6B is a cross-sectional view of the thyristor.

FIG. 6C is a cross-sectional view of another structure of the light emitting thyristor.

FIG. 6D is an equivalent circuit of the thyristors shown in FIGS. 6B and 6C.

Referring to FIG. 6A, the light emitting thyristor 210 includes an anode A, a cathode K, and a gate G.

Referring to FIG. 6B, the light emitting thyristor 210 is fabricated on a GaAs wafer by epitaxially growing a predetermined crystal on a GaAs wafer by known metal organic chemical vapor deposition (MO-CVD). The light emitting thyristor 210 is a three-layer structure including an N type layer 211 (cathode, K), a P type layer 212 (gate, G), and an N type layer 213. An anode A is formed in the P type layer impurity region 214 formed in the N type layer 213.

First, a predetermined sacrificial layer and a buffer layer (not shown) are grown epitaxially on a GaAs wafer. A wafer of a three-layer structure is then fabricated. The three-layer structure includes an N-type layer 213 that contains an N-type impurity, a P-type layer 212 that contains a P-type impurity, and an N-type layer 211 that contains an N-type impurity, in this order. A P-type impurity region 214 is selectively formed in the uppermost N-type layer 213 by photolithography.

Grooves are formed in the wafer to define individual devices by dry etching. When dry etching is performed, a part of the N-type layer 213, which is the uppermost layer of the light emitting thyristor 210, is etched to expose. A metal wiring is formed on the exposed region to form a cathode K. The P-type impurity region 214 and N-type layer 213 are also formed as an anode A and a gate G, respectively.

The light emitting thyristor 210 shown in FIG. 6C is fabricated by epitaxially growing a predetermined crystal on a GaAs wafer by MO-CVD. A cathode K is formed on the N type layer 211, a gate G is formed on the N type layer 213, and an anode A is formed on the P type layer 215.

First, a predetermined sacrificial layer and a buffer layer (not shown) are exitaxially grown. A wafer of a PNPN four-layer structure is then fabricated. The four-layer structure includes an N-type layer 211 that contains an N-type impurity, a P-type layer 212 that contains a p-type impurity, an N-type layer 213 that contains an N-type impurity, and a P-type layer 215 that contains a P-type impurity in this order.

Grooves are formed in the wafer to define individual devices by dry etching. When dry etching is performed, a part of the N-type 211, which is the lowermost layer of the light emitting thyristor 210, is exposed. Likewise, a part of the P-type layer 215, which is the uppermost layer, is exposed. A metal wiring is formed on the exposed region of the P-type layer 215 to form the anode A. At the same time, the gate G is formed on the N-type layer 213.

FIG. 6D illustrates an electrical equivalent circuit of the light emitting thyristor 210 shown in FIGS. 6B and 6C.

As is clear from FIG. 6D, the light emitting thyristor 210 is constituted of a PNP transistor 221 and an NPN transistor 222. The emitter of the PNP transistor 221 corresponds to the anode A of the light emitting thyristors 210 and the base of the PNP transistor 221 corresponds to the gate G. The gate G is also connected to the collector of the NPN transistor 222. The collector of the PNP transistor 221 is connected to the base of the NPN transistor 222. The emitter of the NPN transistor 222 corresponds to the cathode K of the thyristor 210.

The light emitting thyristor 210 shown in FIGS. 6A-6D has an AlGaAs layer formed on a GaAs wafer. The thyristor 210 is not limited to this configuration. The thyristor 210 may have a layer of GaP, GaAsP, or AlGaInP formed on the GaAs wafer or a GaN or AlGaN layer formed on a sapphire substrate.

A composite chip constituted of the light emitting thyristors 210 (210-1, 210-2, . . . ) and driver ICs 100 (100-1, 100-2, . . . ) is manufactured as follows:

The thyristor 210 shown in FIGS. 6B and 6C may be bonded by epitaxially bonding to a wafer on which a plurality of driver ICs 100 shown in FIG. 5 are arranged, and then unwanted portions are removed from the wafer by a known etching technique to expose portions to be formed into terminals of the light emitting thyristor 210. The film wirings are formed by photolithography to connect the terminals of the driver IC 100 to the terminal areas of the light emitting thyristor 210. The wafer is then diced into individual chips of driver ICs by a known dicing technique, thereby obtaining composite chips that include light emitting thyristors 210 and driver ICs 100.

### {Overall Configuration of Driver ICs}

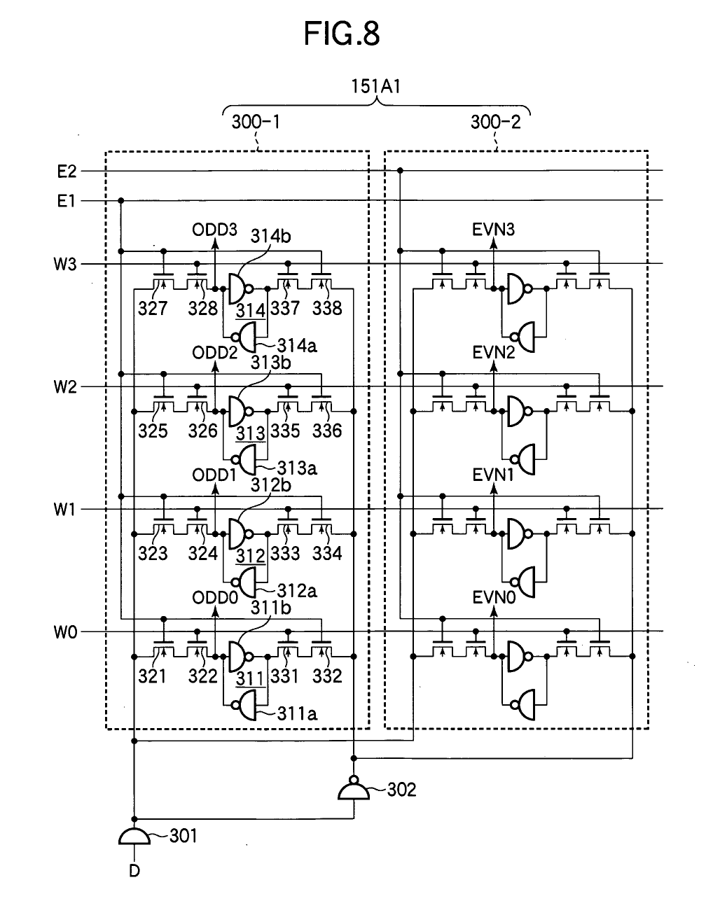

FIG. 7 is a block diagram illustrating the details of one of the driver ICs 100-1, 100-2, . . . 100-26 shown in FIG. 51

Each driver IC 100 includes a shift register 110 constituted of a plurality of cascaded flip flops FFs 111A1-111A25, FFs 111B1-111B25, FFs 111C1-111C25, and FFs 111D1-111D25. The shift register 110 receives the print data signals HD-DATA3 to HD-DATA0 at the data input terminals DATAI3 to DATAI0 on the clock signals HD-CLK received at the clock terminal CLK, while also shifting the print data on the clock CLK.

The flip flops FFs 111A1-111A25 are cascaded and shift the data received at the data input terminal DATAI0. The data input terminal DATAI0 of the driver IC 100 is connected to the data input terminal D of the flip flop FF 111A1. The data output terminals Q of the flip flops FFs 111A24 and 111A25 are connected to the data input terminals A0 and B0 of a shift-stage selector 120, respectively. The output terminal Y0 of the shift-stage selector 120 is connected to a data output terminal DATAO0 of the driver IC 100. Likewise, the flip flops FFs 111B1-111B25, FFs 111C1-111C25, and FFs 111D1-111D25 are also cascaded. Data input terminals DATAI1, DATAI2, and DATAI3 are connected to the data input terminals D of the flip flops FFs 111B1, 111C1, and 111D1. The output terminals Q of the FF111B24, FF111B25, 111C24, 111C25, 111D24, and 111D25 are connected to input terminals A1, A2, A3, B1, B2, and B3 of the shift-stage selector 120, respectively. The output terminals Y1, Y2, and Y3 of the shift-stage selector 120 are connected to data output terminals DATAO1, DATAO2, and DATAO3 of the driver IC 100, respectively.

Thus, the flip flops FFs 111A-111A25, FFs 111B1-111B25, FFs 111C1-111C25, and FFs 111D1-111D25 constitute the 25-stage shift register 110. The shift-stage selector 120 enables switching of the shift register 110 between a 24-stage shift register mode and a 25-stage shift register mode. The data output terminals DATAO0 to DATAO3 of each driver IC 100 are connected to the data input terminals DATAI0 to DATAIO3 of the next driver IC 100 (FIG. 5). The above-described shift register 110 is a part of the shift register constituted of a total of 26 driver ICs 100-1 to 100-26. Thus, for example, the print data signal HD-DATA3 is shifted either in the 24×26 stage shift register mode or in the 25×26 stage shift register mode, and is finally loaded to a driver 181-1 after completion of shifting.

The outputs of the shift register 110 are connected to the inputs of a latch circuit 130 and a memory circuit 150. The outputs of the latch circuit 130 are connected to a driver section 180. A memory controller 141 is connected to the input of the memory circuit 150 whose outputs are connected to a multiplexer 160. A signal selector 142 is connected to the inputs of the multiplexer 160. The drive terminal STB of the driver IC 100 is connected to a pull-up resistor 143 and an inverter 144. An inverter 145 is connected to the latch signal terminal LOAD of the driver IC 100. The output terminals of the inverters 144 and 145 are connected to the input terminals of a 2-input NAND gate 146 whose output terminal is connected to inputs of the driver section 180. Control voltage receiving terminals V of the driver section 180 are connected to a control voltage generator 170.

The latch circuit 130 latches the output signals of the shift register 110 on the latch signal LOAD-P (“P” denotes positive logic) received at the latch signal terminal LOAD. The latch circuit 130 includes a plurality of sub latching elements 131A1-131A24, 131B1-131B24, 131C1-131C24, and 131D1-131D24. Each sub latching element has a data input terminal D, a latch signal input terminal G, and an inverted data output terminal QN. The inverted data output terminals QN of the sub latching elements are connected to the driver section 180.

The memory circuit 150 is controlled by the memory controller 141, and stores correction data (i.e., dot correction data) for correcting the variations of the light emitting thyristors 210, correction data for correcting the variations of the light output of each of the respective light emitting thyristor arrays 200 (i.e., chip correction data), or data unique to each of the respective drivers IC 100. The memory circuit 150 includes a plurality of sub memory circuits 151A1-151A24, 151B1-151B24, 151C1-151C24, and 151D1-151D24 and a sub memory circuit 152. The outputs of the sub memory circuits 151A1-151A24, 151B1-151B24, 151C1-151C24, and 151D1-151D24 are connected to the multiplexer 160 and the outputs of the sub memory circuit 152 are output to the control voltage generator 170. The sub memory circuits 151A1-151A24, 151B1-151B24, 151C1-151C24, and 151D1-151D24 each have a data input terminal D, memory cell selecting terminals W0-W3, write-enable signal input terminals E1 and E2, and data output terminals EVN and ODD. The sub memory circuit 152 has data input terminal D, memory cell selecting terminals W0-W3, a write-enable signal input terminal E1, and data output terminals Q0-Q3. The outputs of the memory circuit 150 are connected to the multiplexer 160 and the control voltage generator 170.

The memory controller 141, which controls the memory circuit 150, has a latch signal terminal LOAD, a drive signal input terminal STB, memory cell selecting signal terminals W0-W3, write-enable signal output terminals E1 and E2. The memory controller 141 outputs memory cell selecting signals from the memory cell selecting signal terminals W0-W3, and write-enable signals from the write-enable signal input terminals E1 and E2 to the plurality of sub memory circuits 151A1-151A24, 151B1-151B24, 151C1-151C24, and 151D1-151D24, and the sub memory circuit 152.

The multiplexer 160 is controlled by the signal selector 142 to select either the correction data for the odd-numbered dots or the correction data for the even-numbered dots, the correction data being outputted from the plurality of sub memory circuits 151A-151A24, 151B1-151B24, 151C1-151C24, and 151D1-151D24. The multiplexer 160 includes a plurality of sub multiplexers 161A1-161A24, 161B1-161B24, 161C1-161C24, and 161D1-161D24, each sub multiplexer having data input terminals EVN and ODD, selection signal terminals S1N and S2N, data output terminals Q0-Q3. The data output terminals Q0-Q3 of the sub multiplexers are connected to the driver 180.

The signal selector 142, which controls the multiplexer 160, has the main scanning sync signal HSYNC terminal, latch signal terminal LOAD, and first and second selection signal terminals S1N and S2N. The signal selector 142 outputs a selection signal from the first selection signal terminal S1N to select the correction data for the odd-numbered and a selection signal from the second selection signal terminal S2N to select the correction data for the even-numbered dots. The first selection signal terminal S1N is connected to the gate drive signal terminal G1 via a gate driver 162-1 and buffers 163-1 to 163-96 or level shifter circuit and the selection signal output terminal S2N is connected to gate drive signal terminal G2 via the buffers 163 and 164. The first gate drivers 162-1 and 162-2 are of the same configuration. The buffers 163 and 164 are of the same configuration.

The control voltage generator 170 is connected to the inputs of the driver section 180, and has data input terminals S0-S3, a reference voltage input terminal VREF, and a control voltage output terminal V. The control voltage generator 170 receives the reference voltage VREF generated by, for example, a regulator circuit (not shown), and generates a control voltage Vcont for driving the light emitting thyristors 210. The control voltage V is supplied to the driver section 180. The control voltage generator 170 maintains the reference voltage VREF at a constant value even if the supply voltage VDD may momentarily drop such as when all of the LEDs are turned on. Thus, the drive current may be kept unchanged.

The driver section 180 outputs drive currents through the drive current output terminals DO01-DO96 for driving the light emitting thyristor arrays 200-1, 200-2, . . . , 200-26, the drive currents being generated in accordance with the outputs of the latch circuit 130, NAND gate 146, multiplexer 160, and control voltage generator 170. The driver section 180 includes drivers 181-1 to 181-96, each driver including data input terminals Q0-Q3, a terminal E, a signal input terminal S, and a control voltage input terminal V.

The NAND gate 146 is connected to the signal input terminals S of the driver section 180, receives the print drive signal HD-STB-N and the latch signal LOAD-P through the inverters 144 and 145, and then outputs a control signal that makes the driver section 180 on or off.

### {Sub Memory Circuits}

Each of the sub memory circuits 151A1-151A24, 151B1-151B24, 151C1-151C24, and 151D1-151D24 in the driver IC 100 shown in FIG. 7 may be substantially identical.

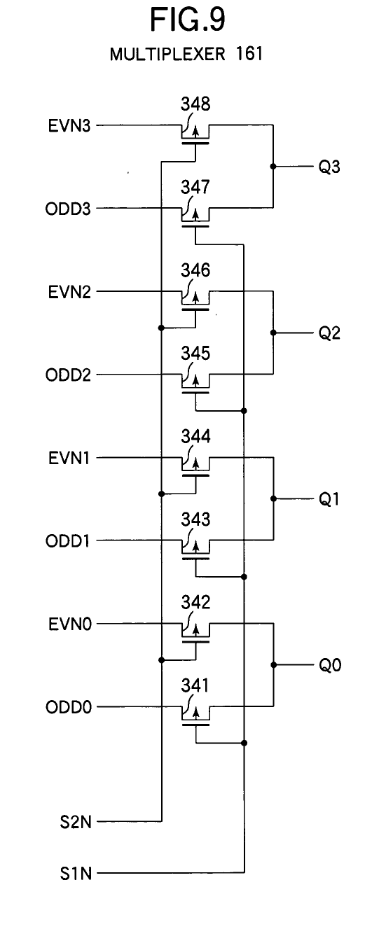

FIG. 8 is a schematic diagram illustrating, by way of example, the configuration of the sub memory circuit 151A1 shown in FIG. 7.

The sub memory circuit, for example, 151A1 shown in FIG. 8 holds 4-bit dot correction data for odd and even numbered dots which can adjust the drive current for a light emitting thyristor in 16 levels, thereby correcting the light output of the light emitting thyristor.

The sub memory circuit 151A1 includes two adjacent, identical memory cell groups 300-1 and 300-2. The memory cell group 300-1 (e.g., dot #1) holds correction data for an odd-numbered dot and the memory cell 300-2 (e.g., dot #2) holds correction data for an even-numbered dot. Each memory cell group includes 4 memory cells, e.g., 311-314, that hold the 4-bit dot correction data for correcting the light output of the light emitting thyristor. The 4-bit dot correction data is capable of setting the drive current in 16 increments for each dot. Each of the memory cell groups 300-1 and 300-2 may be substantially identical; for simplicity only the memory cell group 300-1 will be described, it being understood that the memory cell group 300-2 may work in a similar fashion.

The correction data terminal D of the sub memory circuit 151A1 receives the correction data from the output terminal Q of the flip flop FF 111A1 of the shift register 110. A write-enable signal output terminal E1 receives a write-enable signal, which is outputted from the write-enable signal output terminal E1 of the memory controller 141 and enables writing of the data for odd-numbered dots. Another write-enable signal output terminal E2 receives another write-enable signal, which is outputted from the write-enable signal output terminal E2 of the memory controller 141 and enables writing of the data for even-numbered dots. The memory cell selecting terminals W0-W3 receive memory cell selecting signals from the memory cell selecting terminals W0-W3 of the memory controller 141. The terminals ODD0-ODD3 output the correction data for odd-numbered dots. The terminals EVN0-EVEN3 output the correction data for the even-numbered dots.

The correction data terminal D is connected to the memory cell group 300-1 via a buffer 301. The output of the buffer 301 is connected to the input of an inverter 302 which in turn produces an inverted correction data, i.e., a logic inversion of the correction data.

The memory cell group 300-1 includes memory means (e.g., cells) 311 to 314, data switching means (NMOS transistor switches 321 to 328), and another data switching means (NMOS transistor switches 331 to 338).

The memory cell 311 includes first and second inverters 311a and 311b cascaded to form a ring circuit. In other words, the first inverter has a first output terminal and a first input terminal, and the second inverter has a second output terminal and a second input terminal. The first output terminal is connected to the second input terminal and the second output terminal is connected to the first input terminal. Likewise, the memory cell 312 includes inverters 312a and 312b cascaded to form a ring. The memory cell 313 includes inverters 313a and 313b to form a ring. The memory cell 314 includes inverters 314a and 314b to form a ring. The supply terminals of the inverters 311a, 311b, 312a, 312b, 313a, 313b, 314a, and 314b are connected to the supply terminal VDD to which power supply voltage VDD, e.g., 5 V, is applied.

The gates of NMOS transistors 321, 323, 325, and 327 are connected to the enable signal terminal E1 while the gates of NMOS transistors 322, 324, 326, and 328 are connected to the memory cell selecting terminals W0, W1, W2, and W3, respectively. The output terminal of the buffer 301 is connected to a series circuit of the NMOS transistors 321 and 322, correction data terminal ODD0, and the memory cell 311; a series circuit of NMOS transistors 323 and 324, correction data terminal ODD1, and the memory cell 312; a series circuit of NMOS transistors 325 and 326, correction data terminal ODD2, and the memory cell 313; and a series circuit of NMOS transistors 327 and 328, correction data terminal ODD3, and the memory cell 314.

The gates of NMOS transistors 331, 333, 335, and 337 are connected to the memory cell selecting terminals W0-W3, respectively, and the gates of NMOS transistors 332, 334, 336, and 338 are connected to the enable signal terminal E1. The output of the inverter 302 is connected to a series circuit of the NMOS transistors 332 and 331 and the memory cell 311, a series circuit of the NMOS transistors 334 and 333 and the memory cell 312, a series circuit of the NMOS transistors 336 and 335 and the memory cell 313, and a series circuit of the NMOS transistors 338 and 337 and the memory cell 314.

The memory cell group 300-2 is of the same configuration as the memory cell group 300-1 except that the memory cell group 300-2 is connected to the write-enable signal terminal E2 and correction data terminals EVN0-EVN3.

### {Multiplexer}

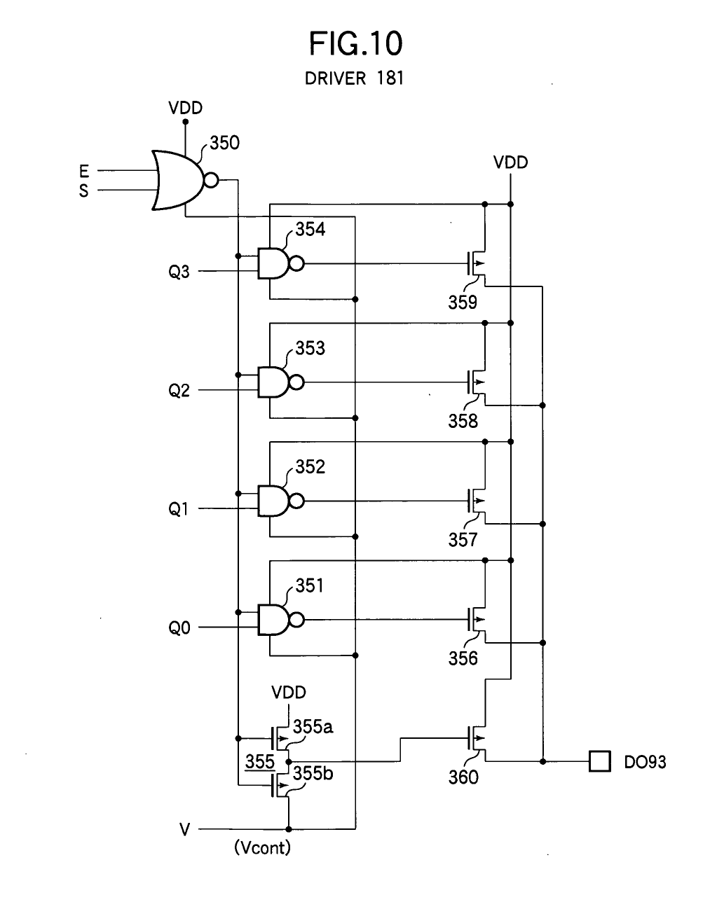

FIG. 9 illustrates the configuration of the multiplexer 161 shown in FIG. 7.

The correction data terminals ODD0-ODD3 of, for example, the sub multiplexer 161A1 receive the correction data from the correction data terminals ODD0-ODD3 of the sub memory circuit 151A1. The correction data terminals EVN0-EVN3 of the sub multiplexer 161A1 receive the correction data from the correction data terminals EVN0-EVN3 of the sub memory circuit 151A1. The selection signal terminals S1N and S2N of the multiplexer 161A1 receive selection signals from the selection signal terminals S1N and S2N of the signal selector 142. Correction data terminals Q0-Q3 output correction data. P channel MOS transistors (referred to as PMOS transistor hereinafter) 341-348 select input data to the sub multiplexer 161A1.

PMOS transistors 341, 343, 345, and 347 are controlled to turn on or off by the selection signal S1N, thereby connecting the correction data terminals ODD0-ODD3 to the correction data terminals Q0-Q3 or disconnecting the correction data terminals ODD0-ODD3 from the correction data terminals Q0-Q3. The PMOS transistors 342, 344, 346, and 348 are controlled to turn on or off by the selection signal S2N applied to their gates, thereby connecting the correction data terminals EVN0-EVN3 to the correction data terminals Q0-Q3 or disconnecting the correction data terminals EVN0-EVN3 from the correction data terminals Q0-Q3.

The multiplexer 161A1 of the above-described configuration employs the PMOS transistors 341-348 as switch elements. The use of the PMOS transistors 341-348 enables a reduction of the number of parts while ensuring reliable operation of the multiplexer 161A.

When the selection signal S1N is set to low (“Low” level) to turn on the PMOS transistor 341, if the correction data ODD0 is at the High level, the correction data Q0 has a substantially equal voltage to the High level of the correction data ODD0. In other words, the PMOS transistor 341 can be used to transfer a signal of the High level without any problem.

However, if the correction data ODD0 is at the Low level, the potential of the drain of the PMOS transistor 341 decreases close to the threshold voltage of the PMOS transistor 341 but not low enough to become the Low level (nearly 0 volts). Thus, the PMOS transistor 341 presents a problem in transferring a signal of the Low level.

In order to solve the above described drawbacks, a conventional art switching means employs, for example, an analog switch which is a parallel connection of a PMOS transistor and an NMOS transistor. This configuration permits generating of an output voltage substantially equal to an input voltage and the insertion of a switch means does not cause any difference between the input voltage and output voltage. However, this configuration necessitates the parallel connection of the PMOS transistor and NMOS transistor for each data line, requiring twice as many components as the configuration shown in FIG. 9. This requires a larger chip area of the IC to accommodate the components.

The configuration of the invention shown in FIG. 9 requires one half as many components as the conventional art that employs analog switches, but presents a problem in transferring a signal of the Low level. However, it is to be noted that a signal of the High level input into the driver 181 connected to the outputs of the multiplexer 161 is required to be substantially equal to the power supply voltage VDD and a signal of the Low level needs only to be as low as the control voltage Vcont which will be described later. In other words, the Low level input to the driver 181 does not need to be substantially 0 volts. For this reasons, the multiplexer shown in FIG. 9 is effective in reducing the number of components while eliminating constraints in the circuit operation.

### {Driver}

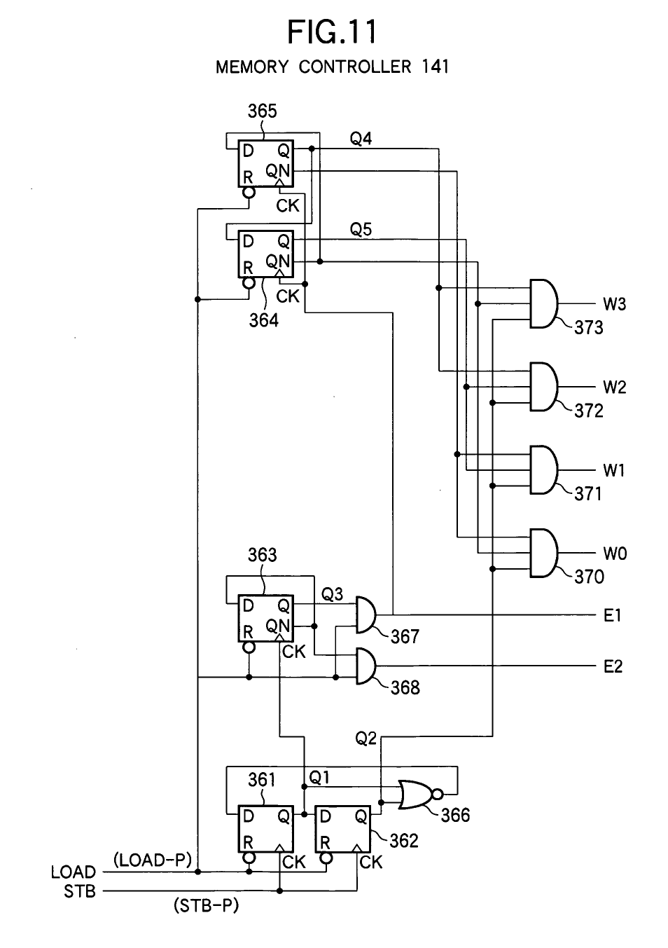

FIG. 10 is the schematic diagram of the driver 181 shown in FIG. 7.

A print data terminal E of the driver 181 (e.g., 181-93) receives print data negative logic) from an inverted output terminal QN of the latch 131A1. A control terminal S receives a negative logic drive signal for driving a light emitting thyristor from the NAND gate 146. The correction data terminals Q0-Q3 receive the correction data from the correction data terminals Q0-Q3 of the multiplexer 161A1. A control voltage receiving terminal V receives a control voltage Vcont from the control voltage output terminal V of the control voltage generator 170. The VDD terminal receives the supply voltage VDD. A drive current output terminal DO outputs the drive current to the anode of a corresponding light emitting thyristor 210 via a thin film wiring (not shown).

The print data terminal E and control terminal S are connected to the input terminals of a 2-input NOR gate 350. The NOR gate 350 has a supply terminal connected to the supply terminal VDD and a ground terminal to which the control voltage Vcont is applied. The output terminal of the NOR gate 350 and the correction data terminals Q0-Q3 are connected to the input terminals of 2-input NAND gates 351-354, respectively. The 2-input NAND gates 351-354 have their supply terminals connected to the VDD terminal and ground terminals connected to the control voltage receiving terminal V to which the control voltage Vcont is applied. The output terminal of the NOR gate 350 is connected to the gates of PMOS transistors 355a and NMOS 355b that constitute a complementary symmetry MOS inverter (i.e., CMOS inverter 355). The PMOS transistor 355a and NMOS transistor 355b are connected in series between the VDD terminal and the control voltage receiving terminal V.

The output terminals of the NAND gates 351-354 are connected to the gates of the PMOS transistors 356-359, respectively. The gate of the PMOS transistor 360 is connected to the output terminal of the CMOS inverter 355. The sources and drains of the PMOS transistors 356-360 are connected in parallel between the VDD terminal and drive current output terminal DO. The PMOS transistor 360 is a main drive transistor that supplies a large portion of the drive current and the PMOS transistors 356-359 are auxiliary transistors that adjust a small portion for the light emitting thyristor, thereby correcting the light output of each light emitting thyristor.

The difference between the voltage (potential) at the VDD terminal and the control voltage Vcont at the control voltage receiving terminal V is substantially equal to the gate-source voltage when the PMOS transistors 356-360 are turned on. Varying the gate-to-source voltage allows adjustment of the drain current of the PMOS transistors 356-360. The control voltage generator 170 shown in FIG. 7, which supplies the control voltage Vcont, controls the control voltage Vcont based on the reference voltage VREF so that the drain currents through the PMOS transistors 356-360 have their corrected values.

For example, the driver 181-93 of the aforementioned configuration operates as follows.

When the print data received at the print data terminal E is ON (Low level or “L”) and the control signal DRVON-N received at the control terminal S is ON (Low level or “L”), the output of the NOR gate 350 is at the High level. At this moment, the outputs of the NAND gates 351-354 and the output of the CMOS inverter 355 become equal to the supply voltage VDD or the control voltage Vcont in response to the data at the correction data terminals Q3-Q0.

The PMOS transistor 360 is controlled by the print data inputted to the print data terminal E. The correction data is outputted from the sub memory circuit 151A1 (FIG. 8) to the correction data terminals Q0-Q3 of the multiplexer 161A1. When the output of the NOR gate 350 goes high, the PMOS transistors 356-359 are selectively driven in accordance with the correction data Q0-Q3 that appears at the correction data terminals Q0-Q3 of the multiplexer 161A1.

In other words, when the PMOS transistor 360 is driven, the PMOS transistors 356-359 are also selectively driven, so that the drive current is the sum of the drain current flowing through the PMOS transistor 360 and the drain currents flowing through the PMOS transistors 356-359. The drive current is supplied to the corresponding light emitting thyristor 210 from the drive current output terminal DO93.

When the PMOS transistors 356-359 are driven, the outputs of the NAND gates 351-354 are low (“L”) (=approximately Vcont), so that the gate voltage of the PMOS transistors 356-359 are nearly equal to the control voltage Vcont. At this moment, the PMOS transistor 355a is OFF and the NMOS 355b is ON so that the gate voltage of the PMOS transistor 360 is also nearly equal to the control voltage Vcont. This implies that the drain currents flowing through the PMOS transistors 356-360 can be adjusted by the single control voltage Vcont. At this moment, the NAND gates 351-354 receive the supply voltage VDD at their supply terminals and the control voltage Vcont at their ground terminals. The input signal can have a voltage between the supply voltage VDD and the control voltage Vcont, and therefore the Low level need not be 0 volts. Thus, the multiplexer 161 shown in FIG. 9 is compatible with the driver 181-93.

### {Memory Controller}

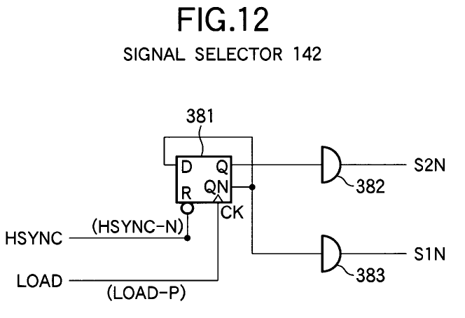

FIG. 11 is a schematic diagram illustrating the configuration of the memory controller 141 shown in FIG. 7.

The latch signal terminal LOAD receives the positive logic latch signal LOAD-P. The drive terminal STB receives a positive logic print drive signal STB-P outputted from the inverter 144 shown in FIG. 7. The memory cell selecting terminals W0-W3 output the memory selecting signal to the memory circuit 150 shown in FIG. 7. The write-enable signal terminals E1 and E2 output the write enable signals to the memory circuit 150. The memory controller 141 also includes flip flops FFs 361-365, 2-input NOR gate 366, 2-input AND gates 367 and 368, and 3-input AND gates 370-373.

The flip-flops FFs 361 and 362 include a negative logic reset terminal R, a clock signal terminal CK, a data input terminal D, and a non-inverted output terminal Q. The reset terminal R receives the latch signal LOAD-P from the latch signal terminal LOAD. The CLK terminal receives the positive logic signal print drive signal STB-P from the drive terminal STB. The output terminal Q outputs the data. Each of the flip-flops FFs 363-365 has a negative logic reset terminal R for receiving the latch signal LOAD-P from the latch signal terminal LOAD. Each of the flip-flops FFs 363-365 also has a clock terminal CK, a data input terminal D, a non-inverted output terminal Q, and an inverted output terminal QN.

The non-inverted output terminals Q of the flip flops FFs 361 and 362 are connected to the inputs of the NOR gate 366. The output of the NOR gate 366 is connected to the input terminal D of the flip flop FF 361. The non-inverted output terminal Q of the flip flop FF 361 is fed to the clock terminal CK of the flip flop FF 363 whose output QN is connected to the input terminal D of the flip flop FF 363. The output terminal Q of the flip flop FF 363 and the latch signal terminal LOAD are connected to the inputs of the AND gate 367 whose output is connected to the write enable signal terminal E1. The output QN of the flip flop FF 363 and the latch signal terminal LOAD are connected to the inputs of the AND gate 368 whose output is connected to the write-enable signal terminal E2.

The output of the AND gate 367 is connected to the clock terminal CK of the flip flops FFs 364 and 365. The negative logic reset terminals R of the flip flops FFs 364 and 365 are connected to the latch signal terminal LOAD. The inverted output terminal QN of the flip flop FF 364 is connected to the input terminal D of the flip flop FF 365. The non-inverted output terminals Q and inverted output terminal QN of the flip flops FFs 364 and 365 and the non-inverted output terminal Q of the flip flop FF 362 are connected to the input terminals of the AND gates 370-373. The outputs of the AND gates 370-373 are connected to the memory cell selecting terminals W0-W3, respectively.

The first input terminal and the second input terminal of the AND gate 373 are connected to the non-inverted output terminal Q of the flip flop FF 365 and the inverted output terminal QN of the flip flop FF 364, respectively. The first input terminal and second input terminal of the AND 372 are connected to the non-inverted output terminal Q of the flip flop FF 364 and the non-inverted output terminal Q of the flip flop FF 365, respectively. The first input terminal and the second input terminal of the AND gate 371 are connected to the inverted output terminal QN of the flip flop FF 365 and the non-inverted output terminal Q of the flip flop FF 364, respectively. The first input terminal and the second input terminal of the AND gate 370 are connected to the inverted output terminal QN of the flip flop FF 365 and the inverted output terminal QN of the flip flop FF 364, respectively.

### {Signal Selector}

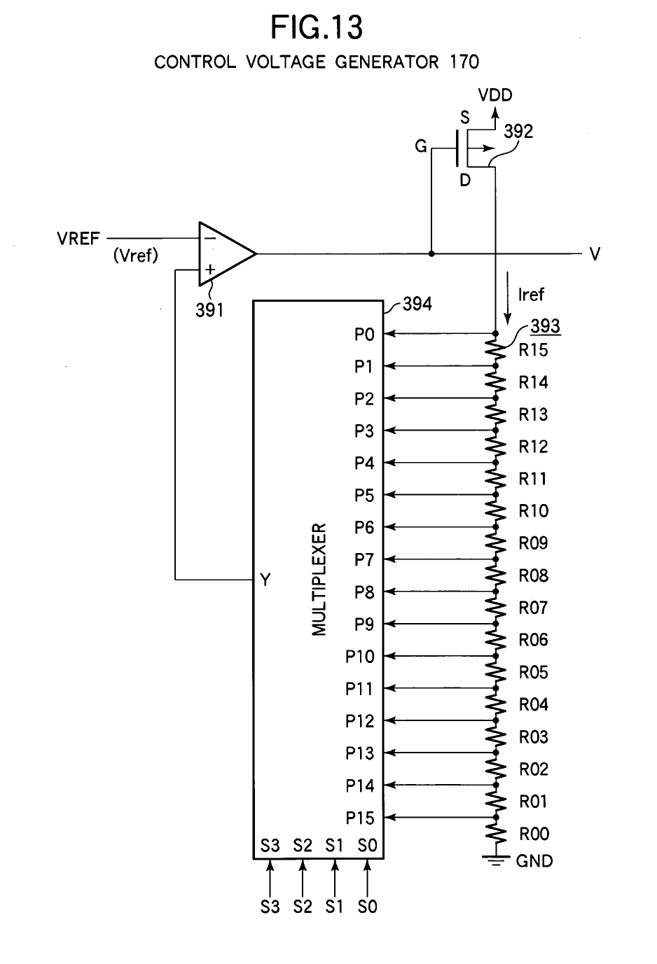

FIG. 12 a schematic diagram illustrating the configuration of the signal selector 142 shown in FIG. 7.

The signal selector 142 has a flip flop FF 381 and buffers 382 and 383. The reset terminal R (negative logic) of the flip flop FF 381 receives the main scanning sync signal HSYNC-N from the sync signal terminal HSYNC of the driver IC 100. A clock terminal CK receives the latch signal LOAD-P (positive logic) from the latch signal terminal LOAD. An input terminal D is connected to an inverted-output terminal QN. A non-inverted output terminal Q outputs a non-inverted output. The signals appearing on the output terminals Q and QN are fed to the selection signal terminals S2N and S1N through the buffers 382 and 383, respectively.

The signal selector 142 is configured to output the selection signals of either the “High” level or the “Low” level to the selection signal terminals S1N and S2N in synchronism with the latch signals LOAD-P received at the clock terminal CK.

### {Control Voltage Generator}

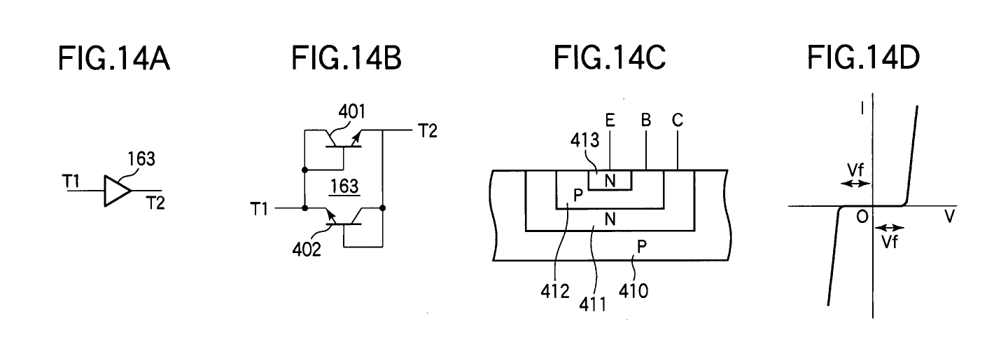

FIG. 13 illustrates the configuration of the control voltage generator 170 shown in FIG. 7.

Each driver IC 100 includes the corresponding control voltage generator 170. The control voltage generator 170 includes an operational amplifier 391, a PMOS transistor 392, a voltage divider 393 including series-connected resistors R00-R15, and an analog multiplexer 394.

The operational amplifier 391 has an inverted input terminal connected to the VREF terminal, a non-inverted input terminal connected to the output terminal Y of the multiplexer 394, and an output terminal connected to the control voltage output terminal V and the gate of the PMOS transistor 392. The PMOS transistor 392 has the same gate length as the PMOS transistors 356-360 shown in FIG. 10. The PMOS transistor 392 has a source connected to the VDD terminal, a gate connected to the output terminal of the operational amplifier 391 and the control voltage output terminal V, and a drain connected to the ground terminal GND through the voltage divider 393.

The multiplexer 394 includes 16 input terminals P0-P15 that receive analog voltages from junction points of the voltage dividing resistors R15-R00 connected in series, an output terminal Y that outputs analog voltage, and input terminals S0-S3 that receive logic signals from the output terminals Q0-Q3 of the sub memory circuit 152 shown in FIG. 7. The four logic signals (S0-S3) are used to produce 16 different logic combinations for selecting one of the input terminals P0-P15, thereby outputting a corresponding analog voltage from the output terminal Y to the non-inverted input terminal of the operational amplifier 391. In other words, one of the input terminals P0-P15 is selected in accordance with a combination of the logic levels at the input terminals S3-S0 of the multiplexer 394, thereby establishing a current path between the output terminal Y and the selected one of the input terminals P0-P15.

The OP amp 391, voltage divider resistors R00-R15, and PMOS transistor 392 constitute a feedback control circuit which maintains the voltage at the non-inverted input terminal of the OP amp 391 substantially equal to the reference voltage VREF. For this reason, the drain current Iref of the PMOS transistor 392 is determined by the resultant resistance of those voltage divider resistors R00-R15 selected by the multiplexer 394 and the reference voltage VREF inputted to the OP amp 391.

For example, when the input terminals S3-S0 of the multiplexer 394 are at logic levels “1,” “1,” “1,” and “1” (i.e., maximum value), respectively, the input terminal P15 is connected to the output terminal Y so that the voltage at the input terminal P15 is substantially the same as the reference VREF. Consequently, the drain current Iref of the PMOS transistor 392 is given as follows:

Iref=VREF/R00

On the other hand, when the logic levels at the terminals S3-S0 are “0,” “1,” “1,” and “1” (i.e., medium value), the input terminal P7 is connected to the output terminal Y so that the voltage at the input terminal P7 is substantially the same as the reference voltage VREF. Consequently, the drain current Iref of the PMOS transistor 392 is given as follows:

Iref=VREF/(R00+R01+R02+R03+R04+R05+R06+R07+R08)

When the logic levels at the terminals S3-S0 are “0,” “0,” 0,” and “0” (i.e., minimum value), respectively, the input terminal P0 of the multiplexer 394 is connected to the output terminal Y of the multiplexer 394 so that the drain current Iref of the PMOS transistor 392 is given as follows:

Iref=VREF/(R00+R01+R02 . . . +R15)

The PMOS transistors 356-360 shown in FIG. 10 and the PMOS transistor 392 shown in FIG. 13 have the same gate length and are driven to operate in their saturation regions, and so one of the PMOS transistors constitute a current mirror of the other. When the PMOS transistors 356-360 become ON, the drain current Iref is proportional to the reference voltage VREF. Therefore, the drain current Iref can be adjusted in 16 increments by selectively setting the logic levels at the input terminals S3-S0 of the multiplexer 394. Thus, the sum of the drain currents through the PMOS transistors 356-360 shown in FIG. 10 can also be adjusted in 16 increments.

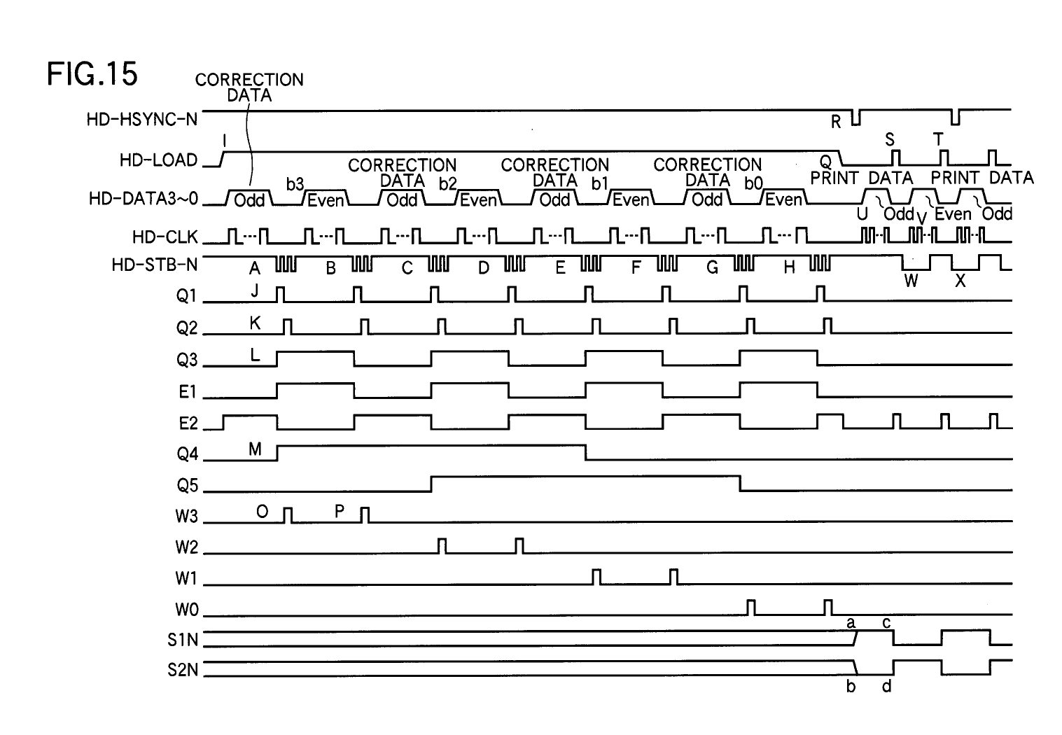

FIGS. 14A-14D illustrate the conceptual representation of individual buffers 163 shown in FIG. 1. FIG. 14A illustrates circuit symbols. FIG. 14B is a circuit diagram of the buffer 163 shown FIG. 14A. FIG. 14C is a cross sectional view of an IC when the buffer 163 is fabricated. FIG. 14D illustrates the relationship between voltage and current of the circuit shown in FIGS. 14B and 14C.

Referring to FIG. 14A, the buffer 163 has an input terminal T1 and an output terminal T2.

Individual buffers 164 shown in FIG. 7 are of the same configuration as the buffers 163 and therefore only the buffer 163 will be described.

Referring to FIG. 14B, each buffer 163 is a reverse-connected parallel circuit of an NPN transistor 401 and an NPN transistor 402. The emitter of the NPN transistor 401 and the base and the collector of the NPN transistor 402 are commonly connected to the output terminal T2. The emitter of the NPN transistor 402 and the base and collector of the NPN transistor 401 are commonly connected to the input terminal T1. When the voltage applied across the input terminal T1 and the output terminal T2 exceeds a threshold value (i.e., Vbe), current can flow through the buffer 163 in a direction either from T1 to T2 or from T2 to T1 depending on the polarity of the voltage.

Referring to FIG. 14C, an N well region 411 is formed in a P type base 410 in which the IC is fabricated. A P well region 412 is formed in the N well region 411. An N type region 413 is formed in the P type well 412.

For simplicity, a gate oxide film, a contact hole, and a passivation film as a protection film are omitted from FIG. 14C. The N type region 413 is connected to an emitter electrode, the P type well region 412 is connected to a base electrode B, and the N well region 411 is connected to a collector electrode C, thereby forming the NPN transistor 401 and the NPN transistor 402.

FIG. 14D plots the voltage V applied across the input terminal T1 and output terminal T2 as the abscissa and the current I flowing between the input terminal T1 and output terminal T2 as the ordinate. The current I starts to flow when the absolute value of the voltage V exceeds a threshold voltage Vf. The threshold voltage Vf is equal to the forward voltage (i.e., Vbe) of the NPN transistors 401 and 402, and is typically about 0.6 V if the buffer 163 is formed of silicon.

### {Overall Operation of Optical Print Head}

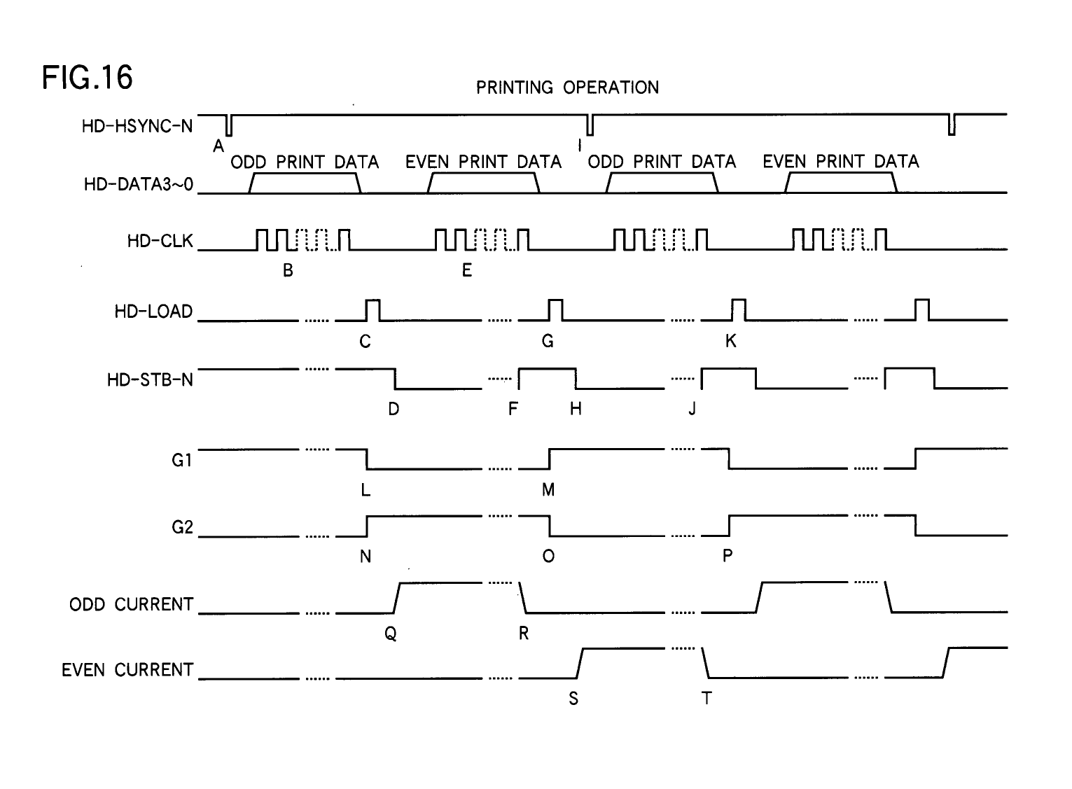

FIG. 15 is a timing chart illustrating the transferring of the correction data performed in the optical print head 13.

Prior to the transferring of the correction data, the latch signal HD-LOAD is set to the High level indicating that the correction data will follow (portion I).

The correction data for one dot is 4-bit data. The data for bit 3, by way of example, of the correction data for an odd-numbered dot is inputted from the print data signals HD-DATA3 to HD-DATA0 into the shift register 110 constituted of the flip flops FF 111A1 to FF 111D24 (FIG. 7), while being shifted by one position upon each clock signal HD-CLK. Upon completion of shifting, three consecutive pulses of the print drive signal HD-STB-N are inputted as depicted at portion A, enabling the memory controller 141 shown in FIG. 11 to operate.

The signals Q1, Q2, Q3, Q4, and Q5 shown in FIG. 15 are signals that appear on the output terminals of the flip flops FFs 361, 362, 363, 365, and 364 shown in FIG. 11, respectively. The write-enable signal terminals E1 and E2 are connected to the outputs of the AND gates 367 and 368. The memory cell selecting terminals W3-W0 are connected to the outputs of the AND gates 373, 372, 371, and 370. The selection signal terminals S1N and S2N are connected to the output terminals of the buffers 383 and 382 shown in FIG. 12, respectively.

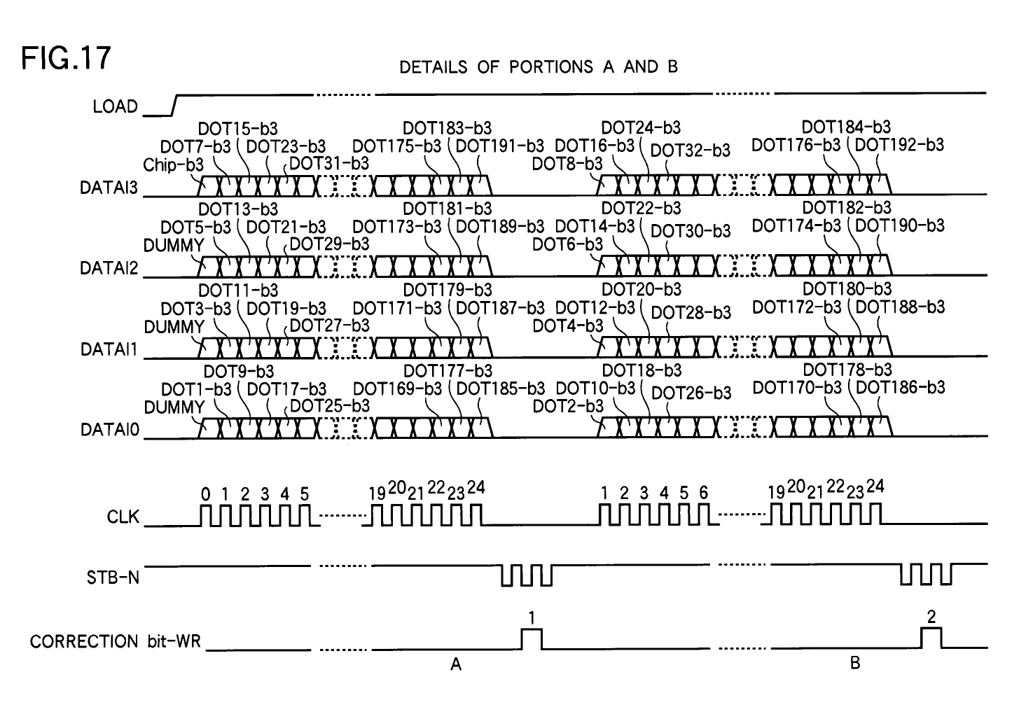

When the first pulse of the print drive signal HD-STB-N is received as depicted at portion “A,” the signal Q1 appears (portion J). When the second pulse of the print drive signal HD-STB-N is received, the signal Q2 appears (portion K). The signal Q3 appearing on the output terminal of the flip flop FF 363 turns each time the signal Q1 appears. For example, the signal Q3 goes high as the first signal at the output terminal Q1 as illustrated in FIG. 16, and goes low as the second signal at the output terminal Q1. FIG. 16 is a timing chart illustrating a printing operation of the image forming apparatus 1 of the first embodiment. The signals at the output terminals Q3 and QN of the flip flop FF 363 are fed to the AND gates 367 and 368, respectively, the AND gates 367 and 368 outputting the write-enable signals E1 and E2, respectively.

The signal at the Q4 terminal rises as depicted at portion M on the rising edge of the write-enable signal E1. The signal at the Q5 terminal rises on the next rising edge of the write-enable signal E1. The signal at the Q4 terminal falls on the still next rising edge of the write-enable signal E1. The signal at the Q5 terminal falls on the further next rising edge of the write-enable signal E1.

The memory cell selecting signals W3-W0 are generated in order on the rising edge of the signal on the Q2 terminal, each having two consecutive pulses (e.g., portions O and P).

Data is written into the memory circuit 151 shown in FIG. 8 on the two pulses of the writes signals W3-W0, the data for odd-numbered dots being written on the first pulse into the memory cells 311-314 in the memory cell group 300-1 and the data for even-numbered dots being written on the second pulse into the memory cells in the memory cell group 300-2.

The first pulses (e.g., portion Q) of the memory selecting signals W3-W0 are clocked by the print drive signal HD-STB-N at portions A, C, E, and G and the second pulses (e.g., portion P) of the memory selecting signals W3-W0 are clocked by the print drive signals HD-STB-N at portions B, D, F, and H.

Once all of the correction data for bit3-bit0 (ODD3-ODD0 and EVN3-EVN0) have been written into the memory cell groups 300-1 and 300-2, the latch signal HD-LOAD is set to the Low level as depicted at portion Q, allowing the print data signals HD-DATA3 to HD-DATA0 to be transferred to the multiplexer 161. The main scanning sync signal HD-HSYNC-N as depicted at portion R is input into the driver IC 100, indicating that the data for the odd numbered dots will be transferred prior to printing of one line.

The print data signals HD-DATA3 to HD-DATA0 for the odd-numbered dots are shifted through the shift register 110, i.e., through the flip-flops FF 111A1 to FF 111D1, . . . FF 111A24 to FF 111D24 as depicted at portion U, and are then latched into the latch circuit 130 on the latch signal HD-LOAD at portion S.

The print drive signal HD-STB-N then goes low (Low level) as depicted at portion W, thereby causing the light emitting thyristors 210-1, 210-2, . . . 210-192 (FIG. 5) to emit light. The light emitting thyristors 210-1, 210-2, . . . 210-192 continue to emit light as long as the print drive signal HD-STB-N remains at the low level as depicted at portion W and portion X.

Likewise, the print data signals HD-DATA3 to HD-DATA0 for the even numbered dots are shifted through the shift register 110 at portion V.

As shown in FIG. 7, the selection signal SiN outputted from the signal selector 142 is fed to the first gate drivers 162-1 and 163-1 to 163-96 (FIG. 7), which in turn output the gate drive signal G1 to the odd-numbered light emitting thyristors 210-1, 210-3, . . . . The selection signal S2N outputted from the signal selector 142 is fed to the second gate drivers 162-2 and 164-1 to 164-96, which in turn output the gate drive signal G2 to the even-numbered light emitting thyristors 210-2, 210-4, 210-6, . . . .

### {Overall Operation of Optical Print Head}

FIG. 16 is a timing chart illustrating the printing operation of the optical print head 13.

When the light emitting thyristors 210 are driven in the time division manner, the main scanning sync signal HD-HSYNC-N is first received (portion A). At portion B, the print data HD-DATA3 to HD-DATA0 for odd-numbered dots (for the light emitting thyristors 210-1, 210-3, 210-5, . . . ) is received in synchronism with the clock HD-CLK, and is shifted through the shift register 110 in the driver IC 100.

The optical print head 13 has 26 cascaded driver ICs 100 (100-1, 100-2, . . . ). Each driver IC 100 has the drive current output terminals DO0 to DO96 for driving 96 odd-numbered light emitting thyristors. The print data HD-DATA3 to HD-DATA0 for four pixels are shifted simultaneously on a single pulse of the clock HD-CLK. Thus, the number of clock pulses required for shifting the print data HD-DATA3 to HD-DATA0 is given as follows:

$$\frac{96 \times 26}{4} = 624$$

At portion B, upon completion of shifting data for odd-numbered dots of print data for one line, the latch signal HD-LOAD is inputted to the driver IC 100 as shown at portion C, thereby latching the print data HD-DATA3 to HD-DATA0 into the latch circuit 130 from the shift register 110. At this moment, the gate drive signal terminal G1 is at the Low level (portion L) and the gate drive signal terminal G2 is at the High level (portion N).

Subsequently, the NAND gate 146 of the driver IC 100 receives the print drive signal HD-STB-N which commands to drive the thyristor 210 (portion D). In response to the print drive signal HD-STB-N, the drive current output terminals DO1 to DO96 of the driver IC 100 selectively go high in accordance with the print data HD-DATA3 to HD-DATA0, thereby outputting the drive current to the light emitting thyristor 210 (portion Q). In this manner, the odd-numbered light emitting thyristors 210-1, 210-3, . . . are driven to emit light.

The gate of the light emitting thyristor 210-2 is at the High level so that the light emitting thyristor 210-2 remains turned off and no drive current flows from the drive current output terminals DO1 into the light emitting thyristor 210-2. Thus, only the light emitting thyristor 210-1 of light emitting thyristors 210-1 and 210-2 is driven to emit light.

At portion F, the print drive signal HD-STB-N goes high, causing the driver IC 100 to drive none of the light emitting thyristors 210-1, 210-2, . . . 210-192 (portion R).

At portion E, the print data HD-DATA3 to HD-DATA0 for even-numbered dots (for the light emitting thyristors 210-2, 210-4, 210-6, . . . ) is received in synchronism with the clock HD-CLK, and is shifted through the shift register 110 in the driver IC 100. The optical print head 13 has 26 cascaded driver ICs 100 (100-1, 100-2, . . . ). Each driver IC 100 has the drive current output terminals DO0 to DO96 for driving 96 even-numbered light emitting thyristors. The print data HD-DATA3 to HD-DATA0 for four pixels are shifted at a time on a single pulse of the clock HD-CLK. Thus, the number of clock pulses required for shifting the print data HD-DATA3 to HD-DATA0 is given as follows:

$$\frac{96 \times 26}{4} = 624$$

At portion E, upon completion of shifting data for even-numbered dots of print data for one line, the latch signal HD-LOAD is inputted to the driver IC 100 as shown at portion C, thereby latching the print data HD-DATA3 to HD-DATA0 into the latch circuit 130 from the shift register 110. At this moment, the gate drive signal terminal G1 is at the High level (portion M) and the gate drive signal terminal G2 is at the Low level (portion O).

Subsequently, the driver IC 100 receives the print drive signal HD-STB-N which commands to drive the thyristor 210 (portion H). In response to the print drive signal HD-STB-N, the drive current output terminals DO1 to DO96 of the driver IC 100 selectively go high in accordance with the print data HD-DATA3 to HD-DATA0, thereby outputting the drive current to the light emitting thyristors 210-2, 210-4, 210-6, . . . (portion S). In this manner, the even-numbered light emitting thyristors 210-2, 210-4, . . . are driven to emit light.

The gate of the light emitting thyristor 210-1 is at the High level so that the light emitting thyristor 210-1 remains turned off and no drive current flows from the drive current output terminal DO1 into the light emitting thyristor 210-1. Thus, only the light emitting thyristors 210-2 of light emitting thyristors 210-1 and 210-2 is driven to emit light.

At portion J, the print drive signal HD-STB-N goes high, causing the driver IC 100 to drive none of the light emitting thyristors 210-1, 210-2, . . . 210-192 (portion T).

As described above, the odd-numbered light emitting thyristors 210-1, 210-3, 210-5, . . . and the even-numbered light emitting thyristors 210-2, 210-4, 210-6, . . . are driven alternately in a time division manner, thereby driving the light emitting thyristors 210-1, 210-2, 210-3, 210-4, . . . for one line of dots.

### {Details of Transfer of Correction Data}

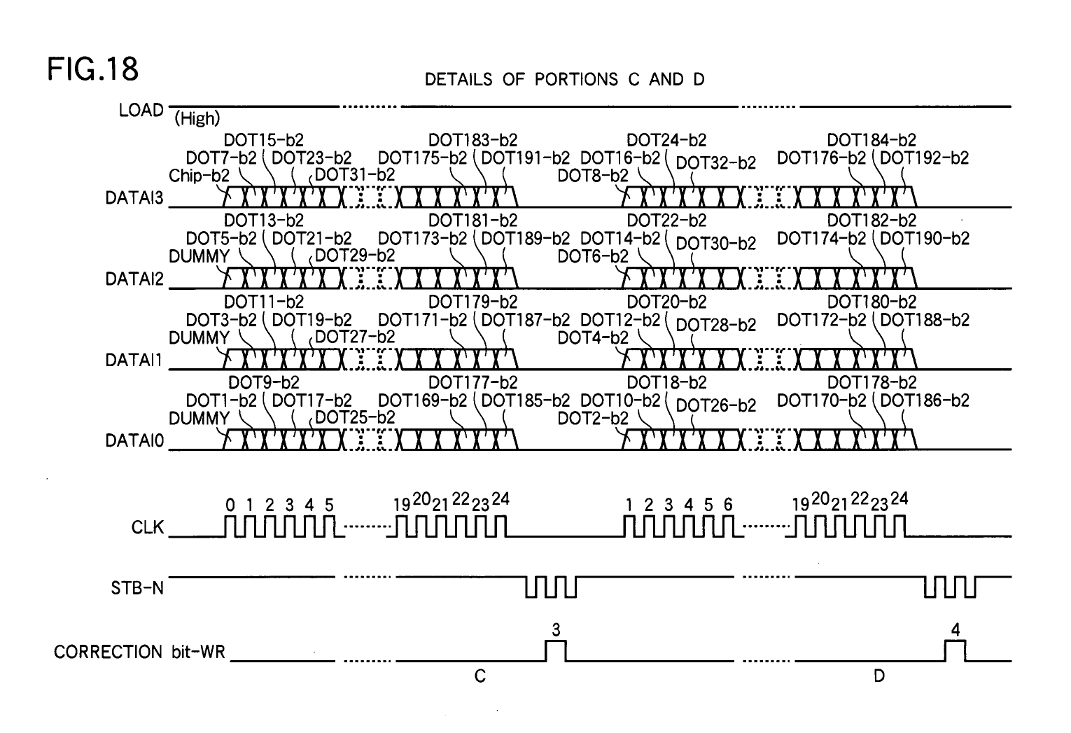

FIGS. 17-20 are timing charts illustrating the waveforms of the respective signals using one of the driver ICs 100-1, 100-2, . . . , 100-26.

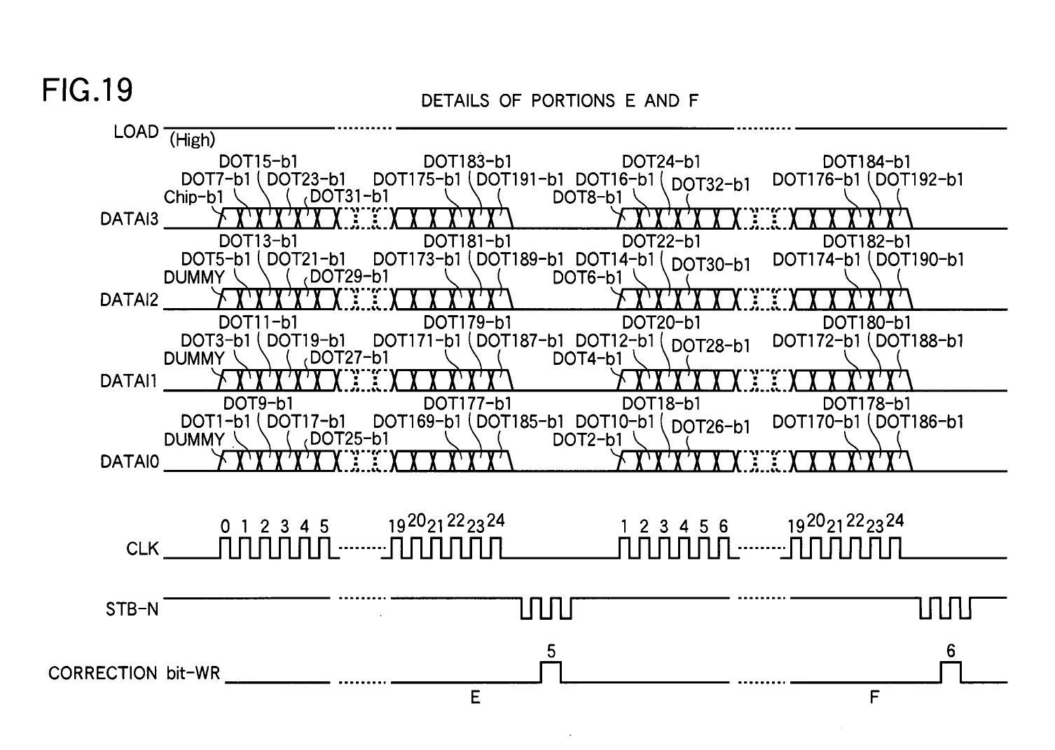

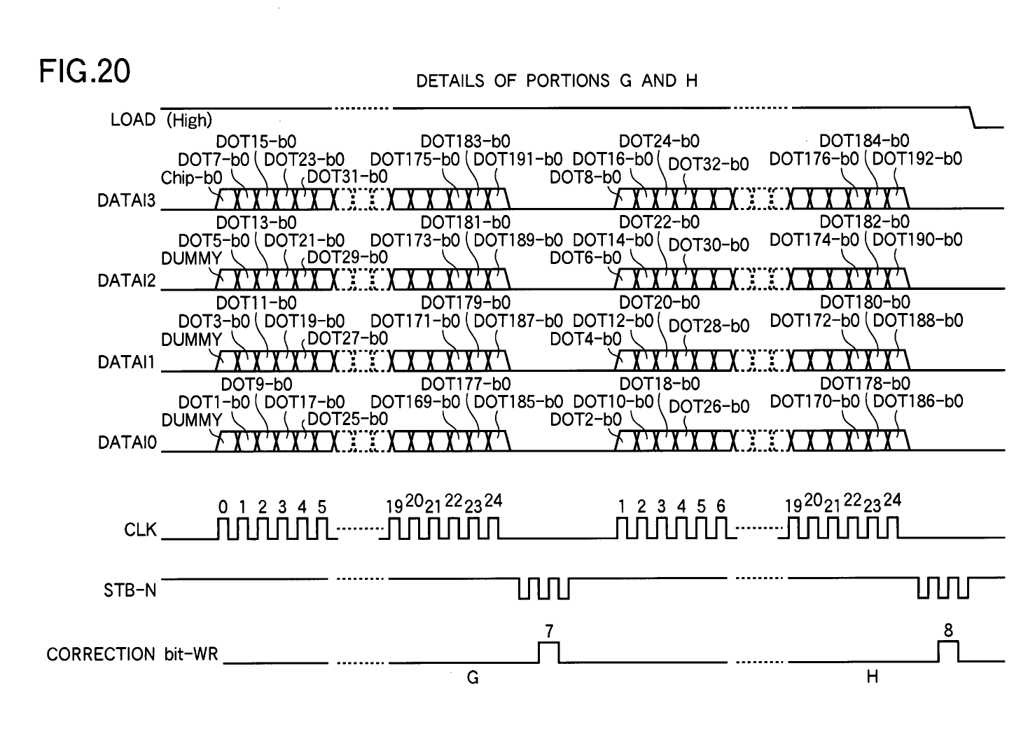

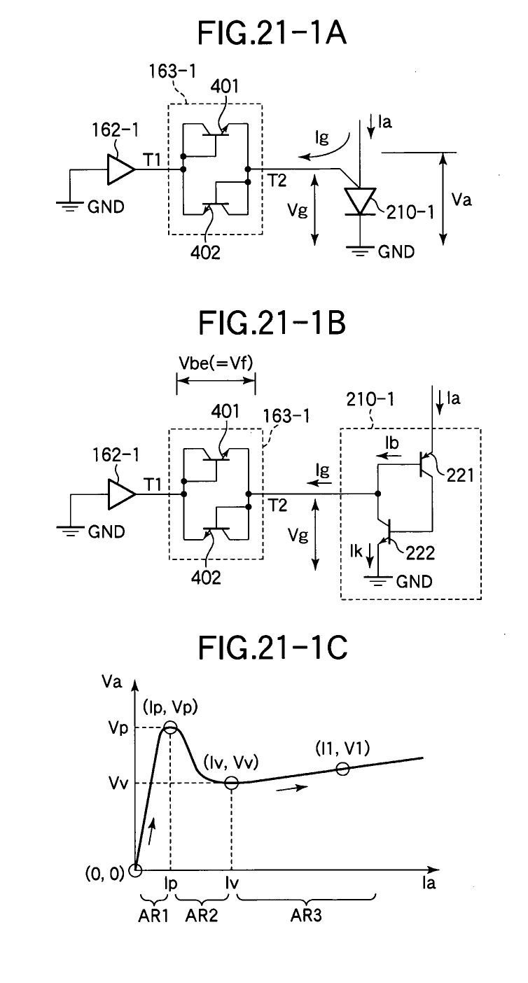

FIG. 17 illustrates the details of the waveforms at portions A and B shown in FIG. 15. FIG. 18 illustrates the details of the waveforms at portions C and D shown in FIG. 15. FIG. 19 illustrates the details of the waveforms at portions E and F shown in FIG. 15. FIG. 20 illustrates the details of the waveforms at portions G and H shown in FIG. 15.

Referring to FIG. 15, the chip correction data chip-b3, chip-b2, chip-b1, and chip-b0 to be set for each driver IC 100 need to be shifted only for either odd-numbered dots (e.g., portion “A”) or even-numbered dots (e.g., portion “B”).

For this purpose, the shift register 110 shown in FIGS. 17-20 has one more stage when the correction data for the odd-numbered dots (portions A, C, E, G, etc.) is shifted than when the correction data for the even-numbered dots is shifted. The chip correction data is added to the top of the string of data when the data is outputted from the printing controller 40.

### {Operation of Light Emitting Thyristor}

The operation of the light emitting thyristors 210-1, 210-2, . . . 210-96 and gate drivers 162-1, and 163-1, 163-2, . . . 163-96 will be described as follows.

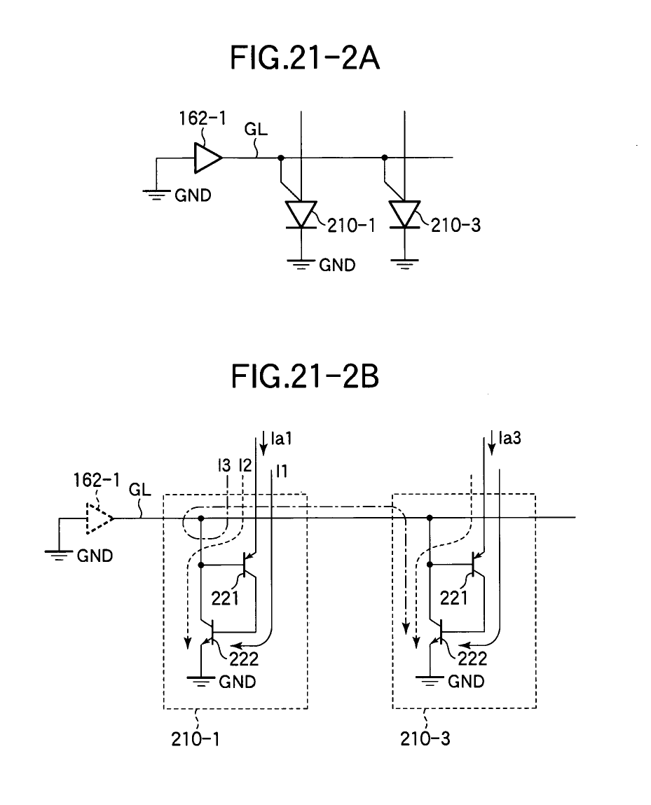

FIGS. 21-1A to 21-1C illustrate the operation of the light emitting thyristor 210-1 (FIG. 7), by way of example, when it is turned on. FIGS. 21-1A and 21-1B are schematic diagrams of a pertinent portion of the buffer 163-1 that drives the gate of the light emitting thyristor 210-1. FIG. 21-1C illustrates the waveforms at the electrodes of the light emitting thyristor 210-1.

Referring to FIGS. 21-1A and 21-1B, the buffer 163-1 is a reverse-connected parallel circuit constituted of the NPN transistors 401 and 402, and has an input terminal T1 and an output terminal T2. The light emitting thyristor 210-1 is constituted of a PNP transistor 221 and an NPN transistor 222. Vbe (Vf) is the base-emitter voltage of NPN transistors 401 and 402. Ib is the base current of the PNP transistor 221. Vg, Ig, Va, and Ik are the gate voltage, gate current, anode voltage, and cathode current of the light emitting thyristor 210-1, respectively.

For example, assume that the input terminal of the gate driver 162-1 shown in FIG. 21-1A is at the Low level. The anode current Ia flows from the DO1 terminal of the driver IC 100 shown in FIG. 6 into the light emitting thyristor 210-1. At this moment, the output terminal of the gate driver 162-1 is at the Low level. The base current Ib is a part of the anode current Ia and flows through the base-emitter junction of the PNP transistor 221. A part of the base current Ib then flows as the gate current Ig of the light emitting thyristor 210-1 through the base-emitter junction of the NPN transistor 402 into the output terminal of the gate driver 162-1.

The output terminal of the gate driver 162-1 is at the Low level, i.e., substantially 0 volts, and the gate voltage Vg of the light emitting thyristor 210-1 is substantially equal to the base-emitter voltage Vbe of the NPN transistors 401 and 402.

Referring to FIG. 21-1B, the gate current Ig of the light emitting thyristor 210-1 is a part of the base current Ib of the PNP transistor 221. The base current Ib causes the PNP transistor 221 to begin to turn on, resulting in the collector current through the PNP transistor 221. The collector current of the PNP transistor 221 flows as the base current into the NPN transistor 222. The collector current of the PNP transistor 221 causes the base current Ib of the PNP transistor 221 to further increase, accelerating the turning on of the PNP transistor 221.

Once the NPN transistor 222 has turned on completely, the collector-emitter voltage of the NPN transistor 222 is lower than the base-emitter voltage Vbe of the NPN transistor 402. As a result, the gate current Ig, which would otherwise flow from the gate of the light emitting thyristor 210-1 shown in FIGS. 21A and 21B to the second terminal T2 of the buffer 163-1, is nearly zero, and a cathode current Ik substantially equal to the anode current Ia flows through the light emitting thyristor 210-1 so that the light emitting thyristor 210-1 becomes ON completely.

FIGS. 21-1C illustrates changes in the anode voltage Va and gate current Ig with the anode current Ia, respectively, when the light emitting thyristor 210-1 shown in FIGS. 21-1A and 21-1B turns on.

FIG. 21-1C plots the anode current Ia as the abscissa and the anode voltage Va as the ordinate.

When the light emitting thyristor 210-1 is OFF, the anode current Ia is substantially zero, which is shown at the origin (0, 0) of the FIG. 21-1C. When the light emitting thyristor 210-1 begins to turn on, the anode voltage Va begins to increase as shown in FIG. 21-1C, reaching a maximum voltage Vp. The voltage Vp of the light emitting thyristor 210-1 is equal to the sum of the emitter-base voltage Vbe of the NPN transistor 402 and the emitter-base voltage Vbe of the PNP transistor 221. The voltage Vp causes the gate current Ig (i.e., base current Ib of the PNP transistor 221).

A circled portion (Ip, Vp) on the curve shown in FIG. 21-1C indicates the boundary between the OFF region AR1 of the light emitting thyristor 210-1 and the ON transition region AR2. As the anode current Ia increases, the anode voltage Va decreases reaching a point (Iv, Vv), which is the boundary between the ON transition region AR2 and the ON region AR3. At this point, the gate current of the light emitting thyristor 210-1 is substantially zero, so that the gate of the light emitting thyristor 210-1 and gate driver 162-1 are effectively electrically isolated by the buffer 163-1.

As the anode current Ia still increases, the anode voltage Va increases, eventually reaching a point (I1, V1) shown in FIG. 21-1C, which is an ultimate operating point of the light emitting thyristor 210-1 where the light emitting thyristor 210-1 emits light in accordance with the anode current Ia.

As described above, the buffer 163-1 shown in FIGS. 21A-1A to 21-1C is used to prevent the gate current Ig from flowing out of the light emitting thyristor 210-1 after the light emitting thyristor 210-1 has turned on, thereby holding the light emitting thyristor 210-1 in its ON state with the anode current Ia substantially equal to the cathode current Ik. This implies that_adjusting the anode current Ia provides a corresponding light output. This operation is achieved by employing the buffer 163-1 placed between the output terminal of the gate driver 162-1 and the gate of the light emitting thyristor 210-1.

If the gate driver 162-1 is implemented by conventional CMOS technology, and is directly connected to the light emitting thyristor 210-1, the Low level of the output of the gate driver 162-1 is nearly 0 volts, which causes the base current Ib of the PNP transistor 221 to continue to flow as the gate current Ig into the output of the gate driver 162-1. This causes a decrease in the collector current of the NPN transistor, and hence a decrease in the cathode current Ik of the light emitting thyristor 210-1. This causes a decrease in the collector current of the NPN transistor, and hence a decrease in the cathode current Ik of the light emitting thyristor 210-1. As a result, the light output of the light emitting thyristor 210-1 deviates from the desired value. This implies that the light emitting thyristor 210-1 would not be applicable to the optical print head 13 of the invention.

In contrast, the buffer 163-1 of the first embodiment reliably drives the gate of the corresponding light emitting thyristor 210-1, eliminating the aforementioned prior art drawbacks as well as providing an image forming apparatus capable of printing images with high quality.

FIGS. 21-2A and 21-2B illustrate a comparative example.

For simplicity, FIG. 21-2A shows only two odd-numbered light emitting thyristors 210-1 and 210-3 connected to the output terminals of a gate driver 162-1. FIG. 21-2B is an electrical equivalent circuit of the light emitting thyristors 210-1 and 210-3 shown in FIG. 21-2A.

The output terminal of the gate driver 162-1 is connected to the gates of the light emitting thyristors 210-1 and 210-3, which are constituted of the PNP transistor 221 and NPN transistor 222. A description will be given of the operation of the light emitting thyristors 210-1 and 210-3 when they are driven to turn on simultaneously.

Assume that the input signal to the gate driver 162-1 shown in FIG. 21-2A is at the Low level.

Referring to FIG. 21-2B, it is assumed that after the output of the gate driver 162-1 has gone low (Low level) to turn on the light emitting thyristors 210-1 and 210-3, substantially no current flows from the gates of the light emitting thyristors 210-1 and 210-3 into the output terminal of the gate driver 162-1. For this reason, the gate driver 162-1 is shown in dotted lines.

Assume that the light emitting thyristor 210-1 has been turned on and an anode current Ia1 is therefore flowing into the anode. The anode current Ia1 is the sum of currents I1, I2, and I3. The current I1 flows into the anode of the light emitting thyristor 210-1, through the emitter-collector junction of the PNP transistor 221, then into the base-emitter junction of the NPN transistor 222. The current I2 flows into the anode of the light emitting thyristor 210-1, through the base-emitter junction of the PNP transistor 221, then into the collector-emitter junction of the NPN transistor 222 to the ground GND. The current I3 flows into the emitter-base junction of the PNP transistor 221 of the light emitting thyristor 210-1, and then into the gate of the light emitting thyristor 210-3 via a common wiring GL. The I3 then flows through the collector emitter junction of the NPN transistor 222 in the light emitting thyristor 210-3 to the ground GND.

The light output of the light emitting thyristors 210-1 and 210-3 of the first embodiment is mainly determined by the current that flows through the collector-emitter junction of the PNP transistor 221. The following is the relation among the currents I1, I2, and I3 in terms of light output that would be produced by the currents I1, I2, and I3 if they effectively contribute to the production of light output.

P1>P2>P3

where P1 is a light output that is produced by the current I1, P2 is a light output that would be produced by the current I2, and P3 is a light output that would be produced by the current I3.

The current I3 does not actually flow through the collector-emitter junction of the PNP transistor 221 and therefore does not contribute to light output. Thus, the current I3 is unwanted.

As described above, the comparative example causes the current I3 that flows through the common wiring GL into the adjacent light emitting thyristor. The current I3 changes in magnitude depending on the variations of gate-cathode voltage of the light emitting thyristors 210-1 and 210-3, the electrical resistance of the common wiring GL, and driving conditions under which the light emitting thyristors 210-1 and 210-3 are driven. Such variations would cause uneven density of printed images, leading to deterioration of print quality.

FIGS. 21-3A and 21-3B illustrate the light emitting thyristors 210-1 and 210-3 . . . of the first embodiment (FIG. 7), by way of example, when they are simultaneously turned on.

For simplicity, FIG. 21-3A shows only two buffers 163-1 and 163-3 connected to an input terminal T1 of a gate driver 162-1, and only two odd-numbered light emitting thyristors 210-1 and 210-3 connected to an output terminal T2 of the gate driver 162-1. The input terminal of the gate driver 162-1 is grounded so that the light emitting thyristors 210-1 and 210-3 are turned on.

FIG. 21-3B is an electrical equivalent circuit of the light emitting thyristors shown in FIG. 21-3A.

For example, assume that the light emitting thyristor 210-1 has been turned on so that the anode current Ia1 is flowing into the light emitting thyristor 210-1. Consider a current path of Ig represented by a dotted line from the light emitting thyristor 210-1 through the buffer 163-1 and then buffer 163-3 to the light emitting thyristor 210-3. The sum of the base-emitter voltage Vbe of the NPN transistor 402, the base-emitter voltage Vbe of the PNP transistor 401, and the collector-emitter voltage Vce3 of the PNP transistor 222 of the light emitting thyristor 210-3 is given as follows:

Vbe+Vbe+Vice=Vg

However, it is to be noted that the gate voltage of the light emitting thyristor 210-1 (i.e., the collector-emitter voltage Vce1 of the NPN transistor 222) is much lower than the voltage Vg. Therefore, the current Ig does not actually flow from the gate of the light emitting thyristor 210-1 through the path represented by the dotted line.

As a result, the base current Ib of the PNP transistor 221 flows through the NPN transistor 222, being a part of the cathode current Ik of the light emitting thyristor 210-1.

To summarize, the configuration of the buffers 163-1 and 163-3 prevents current from flowing from the gates of the light emitting thyristors 210-1 and 210-3 through the output terminal T2 to the buffers 163-1 and 163-3.

As is clear from FIG. 7, for example, the buffers 163-1 and 163-3 are inserted between the gates of the corresponding light emitting thyristors 210-1 and 210-3 and the gate driver 162-1, so that no current flows between the gates of the light emitting thyristors 210-1 and 210-3. It is to be noted that the buffers 163-1 and 163-3 serve as isolators that electrically isolate adjacent light emitting thyristors 210-1 and 210-3 that are simultaneously turned on. Consequently, the anode currents Ia1 and Ia3 flow as the cathode currents Ik through the anode-cathode junction of the light emitter thyristors 210-1 and 210-3, respectively. In other words, the magnitude of the anode currents Ia1 and Ia3 determines the amount of light outputted from the light emitting thyristors 210-1 and 210-3.

As described above, the configuration of the first embodiment is advantageous in that no current flows between the gates of light emitting thyristors that are simultaneously turned on, and in that the light output is determined by the magnitude of the anode current through the light emitting thyristor.

### Effects of First Embodiment

The first embodiment offers the following advantages.

The optical print head 13 includes a plurality of light emitting thyristors 210 divided into a plurality of groups (e.g., a group of even-numbered thyristors and a group of odd-numbered thyristors). The groups are driven in a time division manner. The light emitting thyristors in each group include pairs of adjacent odd-numbered light emitting thyristor and even-numbered light emitting thyristor. The odd-numbered light emitting thyristor and even-numbered light emitting thyristor are connected to their common buffer through corresponding buffers, respectively. This configuration prevents current from flowing between the adjacent odd-numbered light emitting thyristors or between adjacent even-numbered light emitting thyristors, thereby eliminating the variations of light output due to the current that would otherwise flow between the adjacent odd-numbered light emitting thyristors or between the adjacent even-numbered light emitting thyristors.

Minimizing variations of light output minimizes uneven light output of the optical print head 13 and improves space utilization of the optical print head 13, which provides an image forming apparatus 1 capable of printing with excellent print quality. In other words, the optical print head 13 finds application not only in full-color image forming apparatus but also in monochrome image forming apparatus and multi-color image forming apparatus. The optical print head 13 is particularly useful in applications, for example, a full-color image forming apparatus which employs a plurality of optical print heads.

### Second Embodiment

A second embodiment employs an image forming apparatus (FIG. 1), an optical print head 13 (FIG. 6) and driver ICs 100 (FIG. 7) which are of the same configuration as the first embodiment. The second embodiment differs from the first embodiment in that buffers 163A and 164A are employed in place of the buffers 163 and 164. Only the buffer 163A is shown in FIGS. 22A-22D, FIGS. 23-1A and 23-1B, and FIGS. 23-2A and 23-2B.

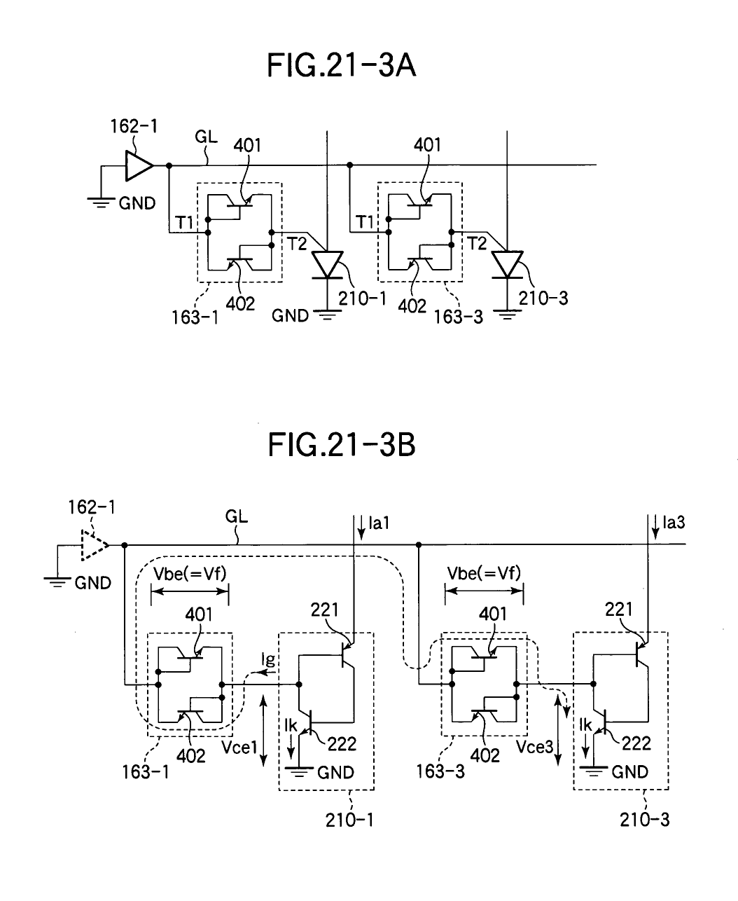

FIGS. 22A-22D are the conceptual representation of buffers 163A. FIG. 22A illustrates the circuit symbol of the buffer 163A. FIG. 22B is an electrical equivalent circuit of the circuit shown in FIG. 22A. FIG. 22C is a cross-sectional view of an IC when the buffer 163A is fabricated. FIG. 22D illustrates the relationship between the voltage and current of the buffer 163A. Elements common to those shown in FIG. 14 of the first embodiment have been given the common reference numerals.

Referring to FIG. 22A, the buffer 163A as an isolator has an input terminal T1 and an output terminal T2.

Referring to FIG. 22B, the buffer 163A is constituted of an NPN transistor 421 and a PNP transistor 422. The emitter of the NPN transistor 421, and the emitter of the PNP transistor 422 are commonly connected to the output terminal T2. The base of the NPN transistor 421 and the base the PNP transistor 422 are commonly connected to the input terminal T1. The collector of the NPN transistor 421 is connected to a VDD terminal and the emitter of the PNP transistor 422 is connected to the ground GND.

Referring to FIG. 22C, an N well region 411 is formed in a P type base 410 that contains a P type impurity. A P type region 414 is formed in the N well region 411 by diffusing a P type impurity.

For simplicity, a gate oxide film, a contact hole, and a passivation film as a protection film are omitted from FIG. 22C. The P type region 414 is connected to an emitter electrode E, the N type well region 411 is connected to a base electrode B, and the P well region 410 is connected to a collector electrode C, thereby forming the PNP transistors 422. The cross-sectional view of the NPN transistor 421 is the same as that of the NPN transistors 401 and 402 shown in FIG. 14C.

FIG. 22D plots the voltage V applied across the input terminal T1 and output terminal T2 as the abscissa and the current I flowing between the input terminal T1 and output terminal T2 as the ordinate. The current I starts to flow when the absolute value of the voltage V exceeds a threshold voltage Vf. The threshold voltage Vf is equal to the base-emitter voltage (i.e., Vbe) of the PNP transistor 422, and is typically about 0.6 V if the buffer 163A is formed of silicon.

### {Operation of Light Emitting Thyristor}

The operation of light emitting thyristors 210-1 to 210-96 and buffers 162-1, 163A-1 to 163A-96 will be described below.

The buffers 163A-1 to 163A-96 play the same role as the buffers 163-1 to 163-96 in the first embodiment.

### {Turning on Light Emitting Thyristor}

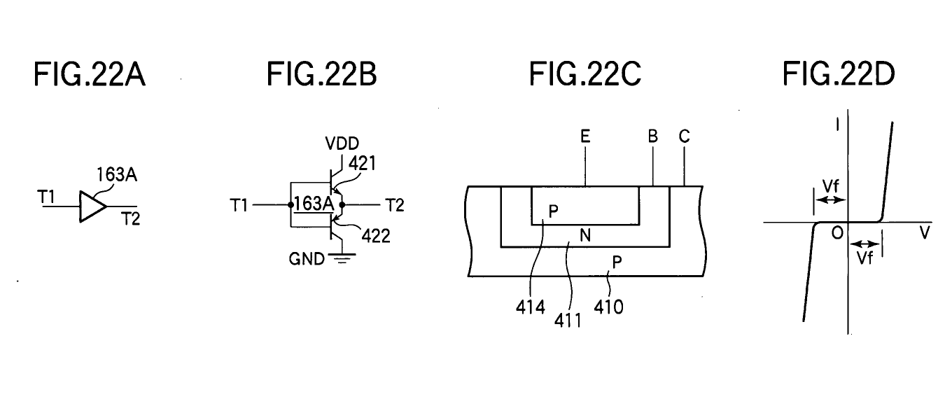

FIGS. 23-1A to 23-1B illustrates the turn-on operation of the light emitting thyristor 210 (FIG. 7). FIGS. 23-1A and 23-1B are schematic diagram illustrating the operation of the buffers 163A-1 to 163A-96. FIG. 23-1C illustrates the waveforms of the electrodes of the light emitting thyristor 210.

By way of example, FIG. 23-1A shows the pertinent portions of the gate driver 162-1, buffer 163A-1, and light emitting thyristor 210-1. FIG. 23-1B shows an electrical equivalent circuit of the circuit shown in FIG. 23-1A.

The gate driver 162-1 is of the same configuration as the first embodiment. The light emitting thyristor 210-1 is constituted of a PNP transistor 221 and an NPN transistor 222. Vbe is the base-emitter voltage of the NPN transistor 421 and PNP transistor 422. Ib is the base current of the PNP transistor 221. Ig is the gate current of the light emitting thyristor 210-1. Va is the anode voltage of the light emitting thyristor 210-1. Ik is the cathode current of the light emitting thyristor 210-1.

For example, assume that the input terminal of the gate driver 162-1 shown in FIG. 23-1A is at the Low level. The anode current Ia flows from the DO1 terminal of the driver IC 100 shown in FIG. 6 into the light emitting thyristor 210-1. At this moment, the output terminal of the gate driver 162-1 is at the Low level. A part of the anode current Ia flows as the base current Ib, which in turn flows through the base-emitter junction of the PNP transistor 221. A part of the base current Ib then flows as the gate current Ig of the light emitting thyristor 210-1 through the base-emitter junction of the NPN transistor 422 into the output terminal of the gate driver 162-1.

The output terminal of the gate driver 162-1 is at the Low level, i.e., substantially, 0 volts, and the gate voltage Vg of the light emitting thyristor 210-1 is substantially equal to the base-emitter voltage Vbe of the PNP transistor 422 or the NPN transistor 421.

Referring to FIG. 23-1B, the gate current Ig of the light emitting thyristor 210-1 is a part of the base current Ib of the PNP transistor 221. The base current Ib causes the PNP transistor 221 to begin to turn on, resulting in the collector current through the PNP transistor 221. The collector current of the PNP transistor 221 flows as the base current into the NPN transistor 222. The collector current of the PNP transistor 221 causes the base current Ib of the PNP transistor 221 to further increase, accelerating the turning on of the PNP transistor 221.

Once the NPN transistor 222 has turned on completely, the collector-emitter voltage of the NPN transistor 222 is lower than the base-emitter voltage Vbe of the NPN transistor 422. Thus, the gate current Ig is nearly zero, which would otherwise flow from the gate of the light emitting thyristor 210-1 shown in FIGS. 23-1A and 23-1B to the output terminal T2 of the buffer 163A-1. Thus, a cathode current Ik substantially equal to the anode current Ia flows through the light emitting thyristor 210-1 so that the light thyristor 210-1 becomes ON completely.

FIG. 23-1C plots the anode current Ia as the abscissa and the anode voltage Va as the ordinate.

When the light emitting thyristor 210-1 is OFF, the anode current Ia is substantially zero, which is shown at the origin (0, 0) of the FIG. 23-1C. When the light emitting thyristor 210-1 begins to turn on, the anode voltage Va begins to increase as shown in FIG. 23-1C, reaching a maximum voltage Vp. The voltage Vp of the light emitting thyristor 210-1 is equal to the sum of the base-emitter voltage Vbe of the PNP transistor 422 and the base-emitter voltage Vbe of the PNP transistor 221. The voltage Vp causes the gate current Ig (i.e., base current Ib of the PNP transistor 221).

A circled portion (Ip, Vp) on the curve shown in FIG. 23-1C indicates the boundary between the OFF region AR1 of the light emitting thyristor 210-1 and the ON transition region AR2. As the anode current Ia increases, the anode voltage Va decreases reaching a point (Iv, Vv), which is the boundary between the ON transition region AR2 and the ON region AR3. At this point, the gate current Ig of the light emitting thyristor 210-1 is substantially zero, so that the buffer 163-1 is effectively disconnected from the light emitting thyristor 210-1.

As the anode current Ia still increases, the anode voltage Va increases, eventually reaching a point (I1, V1) shown in FIG. 23-1C, which is an ultimate operating point of the light emitting thyristor 210-1 where the light emitting thyristor 210-1 emits light in accordance with the anode current Ia.

As described above, the buffer 163A-1 shown in FIGS. 23-1A to 23-1C is used to prevent the gate current Ig from flowing out of the light emitting thyristor 210-1 after the light emitting thyristor 210-1 has turned on, thereby holding the light emitting thyristor 210-1 in its ON state with the anode current Ia substantially equal to the cathode current Ik. This implies that_adjusting the anode current Ia provides a corresponding light output. This operation is achieved by employing the buffer 163A-1 placed between the output terminal of the gate driver 162-1 and the gate of the light emitting thyristor 210-1.

If the gate driver 162-1 is implemented by conventional CMOS technology, and is directly connected to the light emitting thyristor 210-1, the Low level of the output of the gate driver 162-1 is nearly 0 volts, which causes the base current Ib of the PNP transistor 221 to continue to flow as the gate current Ig into the output of the gate driver 162-1. This causes a decrease in the collector current of the NPN transistor, and hence a decrease in the cathode current Ik of the light emitting thyristor 210-1. This causes a decrease in the collector current of the NPN transistor, and hence a decrease the cathode current Ik of the light emitting thyristor 210-1. As a result, the light output of the light emitting thyristor 210-1 deviates from the desired value. This implies that the light emitting thyristor 210-1 may not be applicable to the optical print head 13 of the invention.

In contrast, the buffer 163A-1 of the second embodiment drives the gate of corresponding light emitting thyristor 210-1, eliminating the aforementioned prior art drawbacks as well as providing an image forming apparatus capable of printing images with high quality.

### {Turning on Light Emitting Thyristors Simultaneously}

FIGS. 23-2A and 23-23 illustrate the simultaneous turn-on operation of the light emitting thyristors 210 (FIG. 7), and corresponds to FIGS. 21-3A and 21-3B of the first embodiment.

For simplicity, FIG. 23-2A shows the pertinent portions of only the gate driver 162-1, buffers 163A-1 and 163A-3, and light emitting thyristors 210-1 and 210-3. The buffer 163A-1 has an input terminal T1 connected to the output of the gate driver 162-1 and an output terminal T2 connected to the gate of the light emitting thyristor 210-1. The buffer 163A-3 has an input terminal T1 connected to the output of the gate driver 162-1 and an output terminal T2 connected to the gate of the light emitting thyristor 210-3. When the input of the gate driver 162-1 is at the Low level, the light emitting thyristors 210-1, 210-3, . . . are turned on.

FIG. 23-2B is an electrical equivalent circuit of the light emitting thyristors shown in FIG. 23-2A.

For example, assume that the light emitting thyristor 210-1 has been turned on, so that the anode current Ia1 is flowing into the light emitting thyristor 210-1. Consider a current path of Ig represented by a dotted line from the light emitting thyristor 210-1 through the buffer 163A-1, and then buffer 163A-3 to the light emitting thyristor 210-3. The sum of the base-emitter voltage Vbe of the NPN transistor 442 of the buffer 163A-1 and the base-emitter voltage Vbe of the NPN transistor 421 of the buffer 163A-3 and the collector-emitter voltage Vce3 of the PNP transistor 222 of the light emitting thyristor 210-3 is given as follows:

Vbe+Vbe+Vce3=Vg

However, it is to be noted that the gate voltage of the light emitting thyristor 210-1 (i.e., the collector-emitter voltage Vce1 of the NPN transistor 222) is actually much lower than the voltage Vg. Therefore, the current Ig does not actually flow from the gate of the light emitting thyristor 210-1 through the path represented by the dotted line.

As a result, the base current Ib of the PNP transistor 221 flows through the NPN transistor 222, being a part of the cathode current Ik of the light emitting thyristor 210-1.

To summarize, the configuration of the buffers 163A-1 and 163A-3 prevents current from flowing from the gates of the light emitting thyristors 210-1 and 210-3 to the output terminals T2 of the buffers 163A-1 and 163A-3, respectively.

As is clear from FIGS. 6 and 7, the buffers 163A-1, 163A-3, . . . are inserted between the gates of the corresponding light emitting thyristors 210-1, 210-3 and the gate driver 162-1, so that no current flows between the gates of the light emitting thyristors 210-1 and 210-3. It is to be noted that the buffer 163A-1, 163A-3, . . . serve as isolators that electrically isolate adjacent light emitting thyristors. Consequently, the anode currents Ia1 and Ia3 flow as the cathode currents Ik through the anode-cathode junction of the light emitter thyristors 210-1 and 210-3, respectively. In other words, the magnitude of the anode currents Ia1 and Ia3 determines the amount of light outputted from the light emitting thyristors 210-1 and 210-3, respectively.

As described above, the configuration of the second embodiment is advantageous in that no current flows between the gate of light emitting thyristors that are simultaneously turned on, and in that the light output is determined only by the magnitude of the anode currents of light emitting thyristors.

The buffers 163A-1 and 163A-3 provide as good effects as the buffers 163-1 and 163-3.

### {Modification #1}

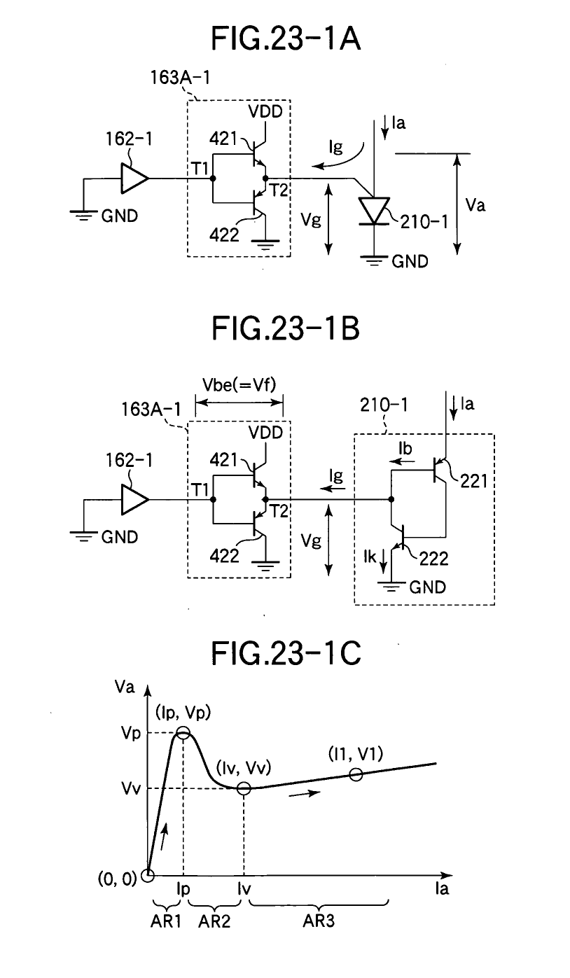

FIGS. 24A-24C are the conceptual representation of a buffer 163B, i.e., a modification #1 to the buffer 163A. FIG. 24A illustrates a circuit symbol of the buffer 163B. FIG. 24B is an electrical equivalent circuit of the circuit shown in FIG. 24A. FIG. 24C illustrates the relationship between the voltage and current of the buffer 163B.

Referring to FIG. 24A, the buffer 163B has an input terminal T1 and an output terminal T2.

Referring to FIG. 24B, the buffer 163B is constituted of two PNP transistors 431 and 432. The bases of the PNP transistor 431 and the emitter of the PNP transistor 432 are commonly connected to the output terminal T2. The emitter of the PNP transistor 431 and the base of the PNP transistor 432 are commonly connected to the input terminal T1. The collector of the PNP transistors 431 and 432 is connected to the ground.

FIG. 24C illustrates the relationship between the voltage and current of the buffer 163B, and plots the voltage V applied across the input terminal T1 and the output terminal T2 as the abscissa, and the current I that flows between the input terminal T1 and the output terminal T2. When the absolute value of the voltage V exceeds a reference voltage Vf, the current I starts to flow. The reference voltage Vf is equal to the base-emitter voltage of the PNP transistors 431 and 432, and is typically about 0.6 V if the buffer 163B is fabricated using a silicon substrate.

Inserting the buffer 163B between the gate of the light emitting thyristor and the gate driver 162-1 provides effects similar to those of the buffer 163A.

### {Modification #2}

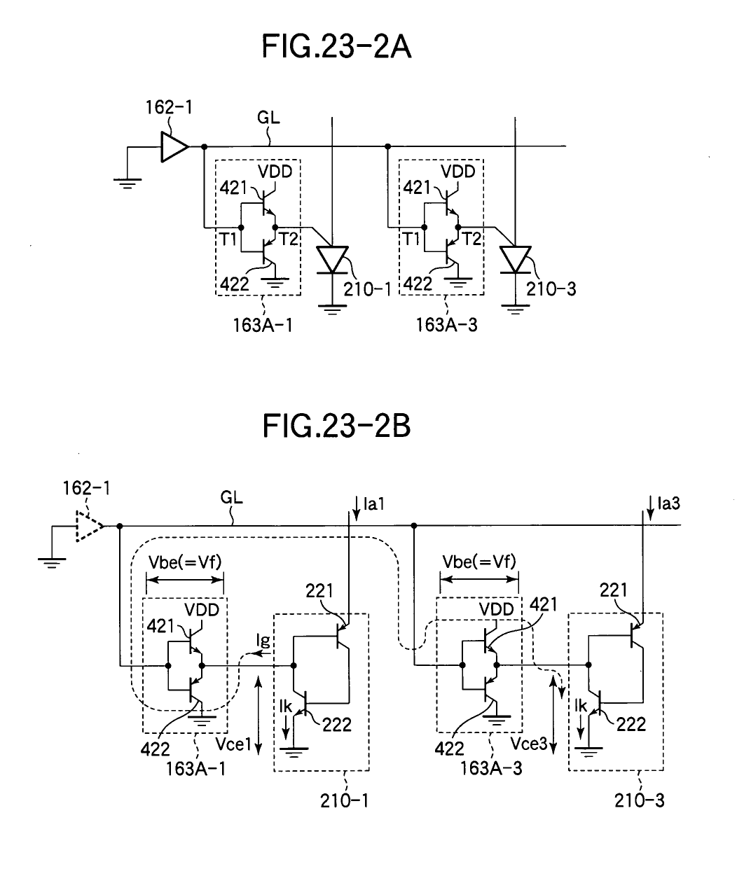

FIGS. 25A-25C illustrate the conceptual representation of a buffer 163C, i.e., a modification #2 to the buffer 163A. FIG. 25A illustrates the circuit symbol of the buffer 163C. FIG. 25B is an electrical equivalent circuit of the circuit shown in FIG. 25A. FIG. 25C illustrates the relationship between the voltage and current of the buffer 163C.

Referring to FIG. 25A, the buffer 163C has an input terminal T1 and an output terminal T2.

Referring to FIG. 25B, the buffer 163C is constituted of two NPN transistors 441 and 442. The base of the NPN transistor 442 and the emitter of the NPN transistor 441 are commonly connected to the output terminal T2. The emitter of the NPN transistor 442 and the base of the NPN transistor 441 are commonly connected to the input terminal T1.

FIG. 250 illustrates the relationship between the voltage and current of the buffer 163C, and plots the voltage V applied across the input terminal T1 and output terminal T2 as the abscissa, and the current I that flows between the input terminal T1 and output terminal T2. When the absolute value of the voltage V exceeds a reference voltage Vf, the current I starts to flow. The reference voltage Vf is equal to the base-emitter voltage of the NPN transistors 441 and 442 and is typically about 0.6 V if the buffer 163B is fabricated using a silicon substrate.

Inserting the buffer 163C between the gate of the light emitting thyristor 210 and the gate driver 162-1 provides effects similar to those of the buffer 163A.

### {Modification #3}

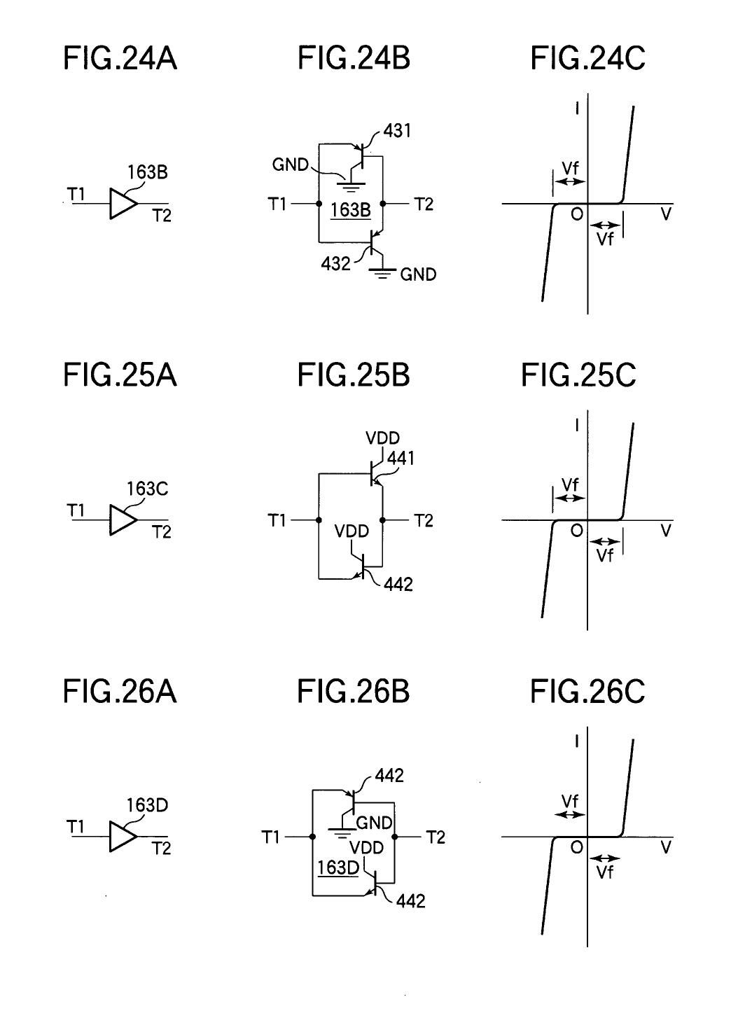

FIGS. 26A-26C are the conceptual representation of a buffer 163D, i.e., a modification #3 to the buffer 163A. FIG. 26A illustrates the circuit symbol of the buffer 163D. FIG. 26B is an electrical equivalent circuit of the circuit shown in FIG. 26A. FIG. 26C illustrates the relationship between the voltage and current of the buffer 163D.

The buffer 163D has an input terminal T1 and an output terminal T2.

Referring to FIG. 26B, the buffer 163D is constituted of a PNP transistor 451 and an NPN transistor 452. The emitter of the PNP transistor 451 and the emitter of the NPN transistor 452 are commonly connected to the input terminal T1. The base of the PNP transistor 451 and the base of the NPN transistor 452 are commonly connected to the input terminal T2.

FIG. 26C illustrates the relationship between the voltage and current of the buffer 163D, and plots the voltage V applied across the input terminal T1 and the output terminal T2 as the abscissa, and the current I that flows between the input terminal T1 and the output terminal T2 as the ordinate. When the absolute value of the voltage V exceeds a reference voltage Vf, the current I starts to flow. The reference voltage Vf is equal to the base-emitter voltage Vbe of the PNP transistor 451 and NPN transistor 452, and is typically about 0.6 V if the buffer 163D is fabricated using a silicon substrate.

Inserting the buffer 163D between the gate of the light emitting thyristor 210 and the gate driver 162-1 provides effects similar to those of the buffer 163D.

### {Other Modifications}

Additional modifications may be made to the first and second embodiment as follows:

The first and second embodiments have been described with respect to the light emitting thyristor 210 as a light source. The present invention may also be applied to other elements in which thyristors are employed as switching elements. For example, the present invention may be applied to printers equipped with an organic EL print head constituted of arrays of organic EL elements and display apparatus equipped with rows of display elements.

The invention may also be applicable to thyristors used as switching elements that drive display elements arranged in a matrix or row. Further, the present invention may also be applicable to a four-terminal thyristor or a silicon controlled switch (SCS) as well as to a three-terminal thyristor.

The first and second embodiments have been described in terms of an N gate type thyristor with a PNPN structure. The invention may also be applicable to a P gate type thyristor or even to a thyristor with a PNPNPN structure. In fact, the invention may be modified in a variety of ways.

What is claimed is:

1. A driver apparatus for driving a plurality of light emitting elements, each including a first terminal connected to a potential source, a second terminal, and a third terminal (G), the driver apparatus comprising:
a current supplying circuit for supplying drive current to each of the light emitting elements such that the drive current flows through each of the light emitting elements from the second terminal to the first terminal;
a driver circuit including an output terminal from which a drive signal is outputted, the drive signal electrically driving the third terminal; and
a level shifter circuit including a fourth terminal connected to the output terminal of the driver circuit and a fifth terminal connected to the third terminal of a corresponding one of the light emitting elements, the level shifter circuit operating such that the drive signal is shifted down in signal level and is outputted to the fifth terminal and a signal inputted to the fifth terminal is shifted down in signal level and is outputted to the fourth terminal.

2. The driver apparatus according to claim 1, wherein the potential source is the ground.

3. The driver apparatus according to claim 1, wherein the level shifter circuit permits current to flow from the fourth terminal to the fifth terminal if the drive signal has a higher voltage than a reference voltage and permits current to flow from the fifth terminal to the fourth terminal if the signal inputted from the third terminal to the fifth terminal has a higher voltage than the reference voltage.

4. The driver apparatus according to claim 1, wherein the level shifter circuit includes a reverse-connected parallel circuit of a first transistor and a second transistor.

5. The driver apparatus according to claim 3, wherein the level shifter circuit includes a first transistor connected across the fourth terminal and the fifth terminal and a second transistor connected across the fourth terminal and the fifth terminal.

6. The driver apparatus according to claim 1, wherein the first transistor and the second transistor are bipolar transistors.

7. The driver apparatus according to claim 1, wherein the light emitting elements are light emitting thyristors.

8. A print head incorporating a driver apparatus according to claim 1.

9. An image forming apparatus incorporating a print head according to claim 7, wherein the print head illuminates an image bearing body to form an image, and
wherein the image forming apparatus forms the image on a print medium.
